(19) United States
(12) Patent Application Publication
(10) Pub. No.: US 2015/0186023 A1
(43) Pub. Date: Jul. 2, 2015

(54) PARAMETER MEASURING DEVICE WITH MANUAL OVERRIDE SELECTION

(71) Applicant: Welch Allyn, Inc., Skaneateles Falls, NY (US)

(72) Inventors: Kristin A. Alisanski, Syracuse, NY (US); Frank LoMascolo, Auburn, NY (US); Kathryn M. Coles, Syracuse, NY (US); Michele M. Donovan, Auburn, NY (US); David D. Gamble, East Syracuse, NY (US); Eric G. Petersen, Aloha, OR (US); Thomas A. Myers, Syracuse, NY (US); Gregory P. Vassallo, Manlius, NY (US)

(21) Appl. No.: 14/577,401

(22) Filed: Dec. 19, 2014

Related U.S. Application Data
(60) Provisional application No. 61/921,897, filed on Dec. 30, 2013.

(51) Int. Cl. G06F 3/0484; G06F 19/00

(52) U.S. Cl. CPC G06F 3/04847; G06F 3/04842; G06F 19/321

(57) ABSTRACT

A parameter measuring device operates to: obtain a first measurement of a parameter; display a workflow screen containing a first representation of the parameter based on the first measurement of the parameter; detect a first manual override selection corresponding to interaction of the user in relation to the input device; receive a second measurement of the parameter via the input device; and display a second representation of the parameter based on the second measurement of the parameter by replacing the first representation of the parameter with the second representation of the parameter

### BACKGROUND

Health care practitioners, such as nurses or physicians, use various types of health-care equipment to assist with the task of providing health care to a patient, also referred to herein as a health-care recipient. Some health-care equipment includes one or more modules that are designed to perform one or more functions, such as temperature measurement and blood pressure measurement. Such measurements obtained by the modules are displayed on a screen of the equipment so that health care practitioners are able to monitor the physiological parameters of the health-care recipient.

### SUMMARY

In general terms, this disclosure is directed to a parameter measuring device. Various aspects are described in this disclosure, which include, but are not limited to, the following aspects. One aspect is a parameter measuring device comprising: a central processing unit configured to control operation of the parameter measuring device; an input device configured to allow a user to input a measurement of the parameter; and a set of one or more computer readable data storage media storing software instructions that, when executed by the central processing unit, cause the parameter measuring device to: obtain a first measurement of a parameter; display a workflow screen containing a first representation of the parameter based on the first measurement of the parameter; detect a first manual override selection corresponding to interaction of the user in relation to the input device; receive a second measurement of the parameter via the input device; and display a second representation of the parameter based on the second measurement of the parameter by replacing the first representation of the parameter with the second representation of the parameter.

Another aspect is a parameter measuring device comprising: a central processing unit configured to control operation of the parameter measuring device; a touch-sensitive display screen; and a set of one or more computer readable data storage media storing software instructions that, when executed by the central processing unit, cause the parameter measuring device to: obtain a first measurement of a parameter; display, on the touch-sensitive display screen, a workflow screen containing a first representation of the parameter based on the first measurement of the parameter; detect a first manual override selection corresponding to interaction of a user in relation to the touch-sensitive display screen; display a virtual input device on the touch-sensitive display screen, the virtual input device configured to allow the user to input a measurement of the parameter; receive a second measurement of the parameter; and display, on the touch-sensitive display screen, a second representation of the parameter based on the second measurement of the parameter by replacing the first representation of the parameter with the second representation of the parameter.

A further aspect is a method for measuring parameters, the method comprising: displaying, by a parameter measuring device, a workflow screen on a touch-sensitive display screen; obtaining a first measurement of a parameter; displaying, within the workflow screen on the touch-sensitive display screen, a first representation of the parameter based on the first measurement of the parameter; detecting a first manual override selection corresponding to interaction of a user in relation to the touch-sensitive display screen; displaying a virtual input device on the touch-sensitive display screen, the virtual input device configured to allow the user to input a measurement of the parameter; receiving a second measurement of the parameter; and displaying, on the touch-sensitive display screen, a second representation of the parameter based on the second measurement of the parameter by replacing the first representation of the parameter with the second representation of the parameter.

A further aspect is a computer-readable storage medium comprising software instructions that, when executed, cause a parameter measuring device to: obtain a first measurement of a parameter; display, on a touch-sensitive display screen, a workflow screen containing a first representation of the parameter based on the first measurement of the parameter; detect a first manual override selection corresponding to interaction of a user in relation to the touch-sensitive display screen; display a virtual input device on the touch-sensitive display screen, the virtual input device configured to allow the user to input a measurement of the parameter; receive a second measurement of the parameter; display, on the touch-sensitive display screen, a second representation of the parameter based on the second measurement of the parameter by replacing the first representation of the parameter with the second representation of the parameter; when the parameter is an episodic parameter: determine whether a third measurement of the parameter is obtained; a second manual override selection corresponding to interaction of the user in relation to the touch-sensitive display screen is detected; or a save button within the workflow screen is selected; when the third measurement of the parameter is obtained, display, on the touch-sensitive display screen, a third representation of the parameter based on the third measurement of the parameter by replacing the second representation of the parameter with the third representation of the parameter; when the second manual override selection is detected: display the virtual input device on the touch-sensitive display screen; receive a fourth measurement of the parameter input through the virtual input device; and display, on the touch-sensitive display screen, a fourth representation of the parameter based on the fourth measurement of the parameter by replacing the second representation of the parameter with the fourth representation of the parameter, if the save button is selected: save the second measurement of the parameter in response to selection of the save button after displaying, on the touch-sensitive display screen, the second representation of the parameter; and clear the second representation of the parameter on the touch-sensitive display screen, when the parameter is a continuous parameter: display, on the touch-sensitive display screen, the second representation of the parameter based on the second measurement of the parameter, for a predetermined period of time, by replacing the first representation of the parameter with the second representation of the parameter; clear the second representation of the parameter after the predetermined period of time; and display, on the touch-sensitive display screen, a fifth representation of the parameter based on the first measurement of the parameter, obtain sources of measurements of the parameter; and display, on the touch-sensitive display screen, source representations of the parameter based on the sources of the measurements of the parameter.

### BRIEF DESCRIPTION OF THE DRAWINGS

FIG. 1 is a block diagram illustrating an example system for collecting measurements of physiological parameters of patients.

FIG. 2A is a perspective view of an example parameter measuring platform (PMP) device.

FIG. 2B is a perspective view of the PMP device of FIG. 2A, illustrating an example user interface displayed on the display screen of the PMP device 200.

FIG. 3 is a view of an example workflow screen.

FIG. 4 is a flowchart illustrating an example operation performed by the PMP device for obtaining and overriding measurements of an episodic parameter with a spot profile

FIG. 5 is a flowchart illustrating an example operation for detecting a manual override selection.

FIGS. 6A-6D are views of an example workflow screen, illustrating an example operation of the PMP device for obtaining a manual reading for an episodic parameter with a spot profile.

FIGS. 7A-7F are views of an example workflow screen, illustrating an example operation of the PMP device for obtaining a manual reading for an episodic parameter with an intervals profile.

FIG. 8 is a flowchart illustrating an example operation performed by the PMP device for obtaining and overriding measurements of a continuous parameter.

FIGS. 9A-9E are views of an example workflow screen, illustrating an example operation of the PMP device for obtaining a manual reading for a continuous parameter.

FIG. 10 is a view of an example review screen.

FIG. 11 is a block diagram for example physical components of the PMP device.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

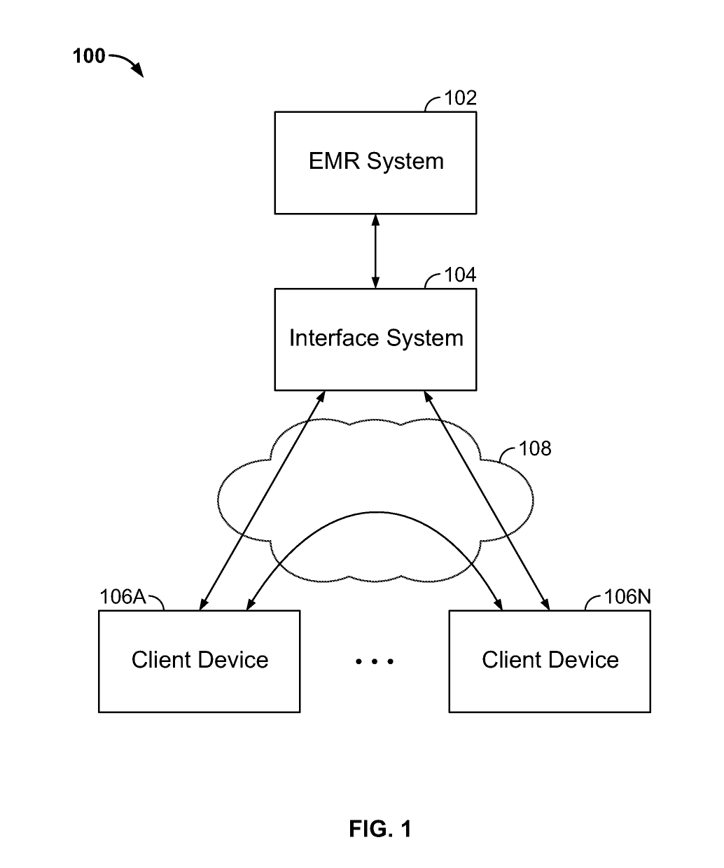

FIG. 1 is a block diagram illustrating an example system 100 for collecting measurements of physiological parameters of patients. The system 100 comprises an Electronic Medical Records (EMR) system 102, an interface system 104, a set of client devices 106A-106N (collectively, “client devices 106”), and a network 108.

The network 108 is an electronic communication network that facilitates communication between the client devices 106 and between the client devices 106 and the interface system 104. An electronic communication network is a set of computing devices and links between the computing devices. The computing devices in the network use the links to enable communication among the computing devices in the network. The network 108 can include routers, switches, mobile access points, bridges, hubs, intrusion detection devices, storage devices, standalone server devices, blade server devices, sensors, desktop computers, firewall devices, laptop computers, handheld computers, mobile telephones, and other types of computing devices. In various embodiments, the network 108 includes various types of links. For example, the network 108 includes wired and/or wireless links. Furthermore, in various embodiments, the network 108 is implemented at various scales. For example, the network 108 can be implemented as one or more local area networks (LANs), metropolitan area networks, subnets, wide area networks (such as the Internet), or can be implemented at another scale.

The EMR system 102 is a computing system that allows storage, retrieval, and manipulation of electronic medical records. As used herein, a computing system is a system of one or more computing devices. A computing device is a physical, tangible device that processes data. Example types of computing devices include personal computers, standalone server computers, blade server computers, mainframe computers, handheld computers, smart phones, special purpose computing devices, and other types of devices that process data.

Each client device in the set of client devices 106 is a computing device that can provide various types of functionality. In some embodiments, the set of client devices 106 includes one or more physiological parameter measuring platform (PMP) devices 200 as explained below in further detail. In addition, the set of client devices 106 can include one or more wall-mounted devices. Such wall-mounted devices can have similar functionality to the PMP device 200 but are stationary instead of portable. The set of client devices 106 can further include one or more monitor devices. Such monitor devices can display representations of physiological parameters, but do not directly obtain measurements of the physiological parameters from patients. In some embodiments, a monitor device is used by a clinician to monitor the physiological parameters of multiple patients at one time.

In some embodiments, the client devices 106 communicate with each other through the network 108. In various embodiments, the client devices 106 can communicate various types of data with each other through the network 108. For example, in embodiments where the set of client devices 106 includes a set of PMP devices and a monitor device, each of the PMP devices can send data representing measurements of physiological parameters of patients to the monitor device. In this way, the monitor device can display representations of physiological parameters to a clinician.

The interface system 104 is a computing system that acts as an interface between the EMR system 102 and the client devices 106. In some embodiments, the interface system 104 is a Connex system. Different EMR systems have different software interfaces. For example, the EMR system used by two different hospitals can have two different software interfaces. The interface system 104 provides a single software interface to each of the client devices 106. The client devices 106 send requests to software interface provided by the interface system 104. When the interface system 104 receives a request from one of the client devices 106, the interface system 104 translates the request into a request that works with the software interface provided by the EMR system 102. The interface system 104 then provides the translated request to the software interface provided by the EMR system 102. When the interface system 104 receives a response from the EMR system 102, the interface system 104 translates the response from a format of the EMR system 102 to a system understood by the client devices 106. The interface system 104 then forwards the translated response to an appropriate one of the client devices 106.

In various embodiments, the client devices 106 sends various types of data to the interface system 104 for storage in the EMR system 102 and receives various types of data from the EMR system 102 through the interface system 104. In some embodiments, for example, the client devices 106 can send measurements of physiological parameters to the interface system 104 for storage in the EMR system 102. In another example, a monitor device can retrieve past measurements of physiological parameter of patients from the EMR system 102 through the interface system 104.

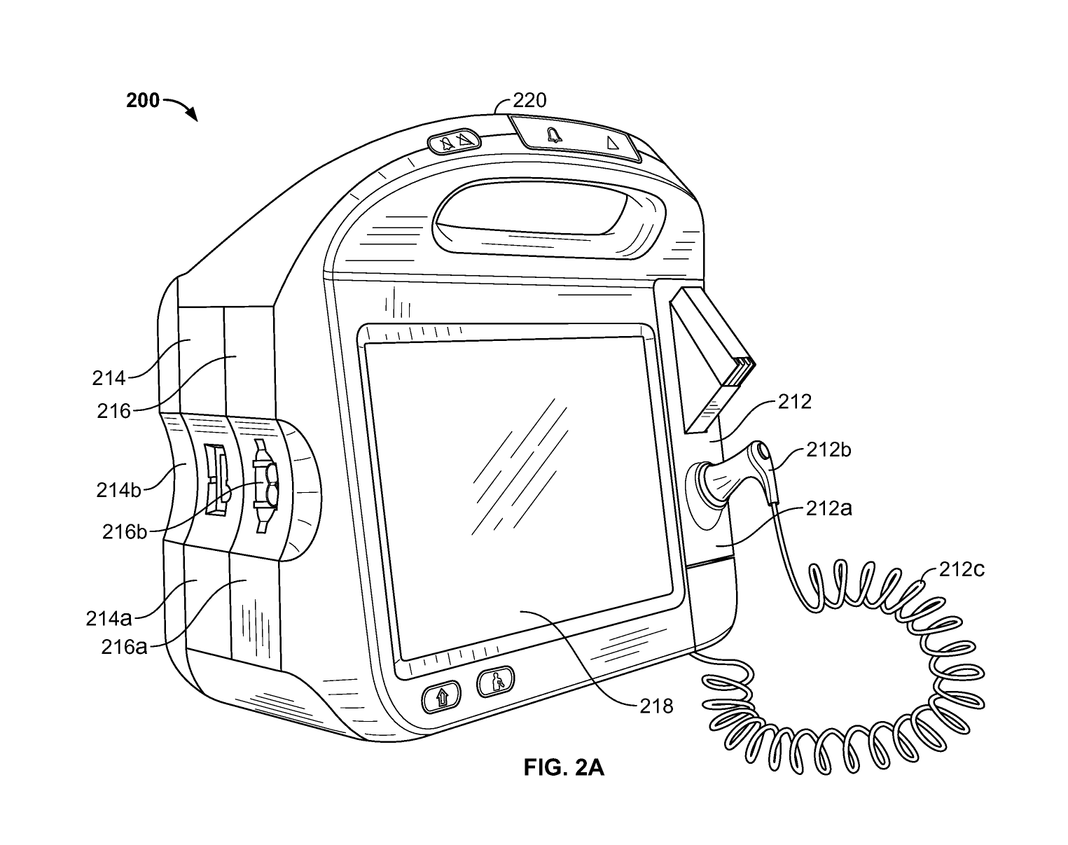

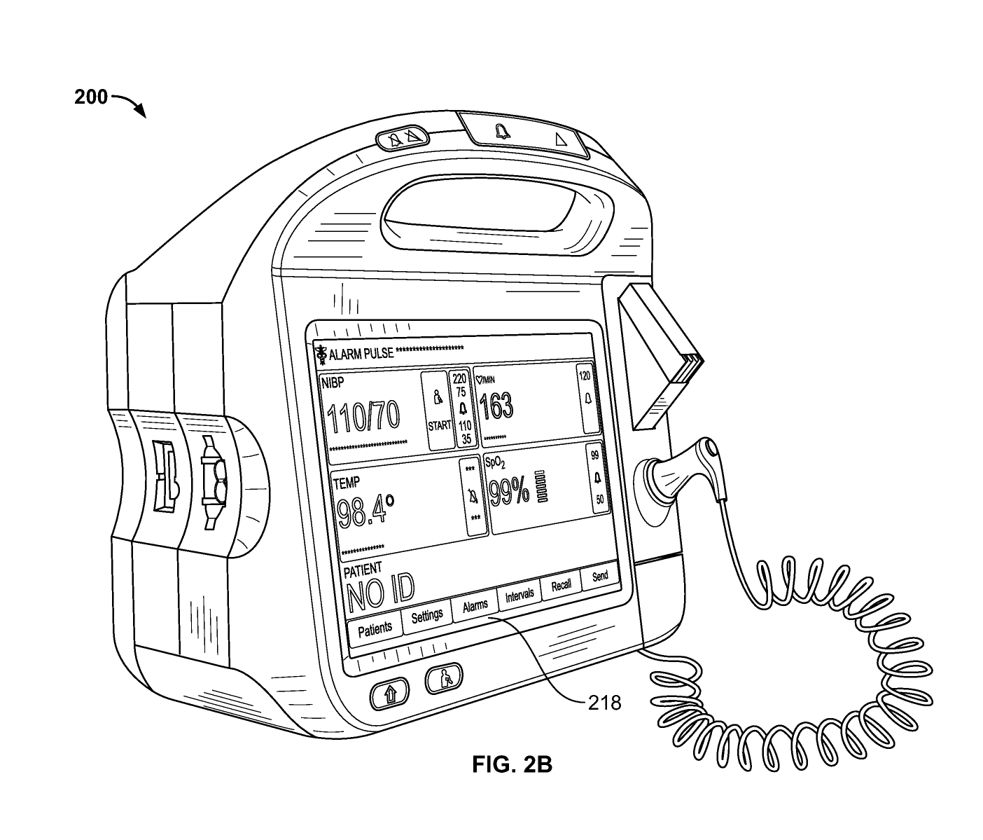

FIG. 2A is a schematic, perspective view of an example PMP device 200. The PMP device 200 is classified and referred to as a portable monitor platform device. The PMP device 200 is functionally connected to one or more sensors that enable monitoring of at least one physiological parameter associated with a patent. Typically, each sensor is physically attached to the patient while the PMP device 200 is operating to acquire measurements of a parameter associated with the sensor. These sensors include a temperature probe, a SpO2 clip and a NIBP blood pressure cuff that are each attachable to the PMP device 200.

In some embodiments, the PMP device 200 includes multiple health care equipment (HCE) modules and a touch-sensitive display screen 218. Each of the HCE modules is configured to measure one or more physiological parameters of a health-care recipient, also referred to herein as a patient. The touch-sensitive display screen 218 is configured to display representations of measurements of the physiological parameters of the patient and to receive commands, instructions, and/or inputs based on interaction of a clinician or user with the touch-sensitive display screen 218.

In some embodiments, the PMP device 200 includes a temperature measurement module 212, a SpO2 module 213, a non-invasive blood pressure (NIBP) module 216, and a respiratory rate module (not shown). As used in this document, a “module” is a combination of a physical module structure which typically resides within the PMP device 200 and optional peripheral components (not shown) that typically attach to and reside outside of the PMP device 200. The PMP device 200 also includes an upper handle portion 220 that enables the PMP device 200 to be carried by hand.

The temperature measurement module 212 includes a front panel 212a. The front panel 212a has an outer surface that is accessible from the front side of the PMP device 200. The front panel 212a provides access to a wall (not shown) storing a removable probe (not shown), also referred to as a temperature probe, that is attached to a probe handle 212b. The probe and its attached probe handle 212b are tethered to the temperature measurement module 212 via an insulated conductor 212c. The probe is designed to make physical contact with a patient in order to sense a body temperature of the patient.

A left hand side of the PMP device 200 includes an outer surface of the SpO2 module 214 and an outer surface of the NIBP module 216. The SpO2 module 214 is a HCE module designed to measure oxygen content within the blood of a patient. The NIBP module 216 is a HCE module designed to measure blood pressure of a patient.

As shown, the SpO2 module 214 includes a front panel 214a. The front panel 214a includes an outer surface that is accessible from the left side of the PMP device 200. The front panel 214a includes a connector 214b that enables a connection between one or more peripheral SpO2 components (not shown) and a portion of the SpO2 module 214 residing inside the PMP device 200. The peripheral SpO2 components reside external to the PMP device 200. The peripheral SpO2 components are configured to interoperate with the SpO2 module 214 when connected to the SpO2 module 214 via the connector 214b. In some embodiments, the peripheral SpO2 components include a clip that attaches to an appendage of a patient, such as a finger. The clip is designed to detect and measure a pulse and an oxygen content of blood flowing within the patient.

As shown, the NIBP module 216 includes a front panel 216a having an outer surface that is accessible from the left side of the PMP device 200. The front panel 216a includes a connector 216b that enables a connection between one or more peripheral NIBP components (not shown) and a portion of the NIBP module 216 residing inside the PMP device 200. The peripheral NIBP components reside external to the PMP device 200. The peripheral NIBP components are configured to interoperate with the NIBP module 216 when connected to the NIBP module 216 via the connector 216b. In some embodiments, the peripheral NIBP components include an inflatable cuff that attaches to an appendage of a patient, such as an upper arm of the patient. The inflatable cuff is designed to measure the systolic and diastolic blood pressure of the patient, the mean arterial pressure (MAP) of the patient, and the pulse rate of blood flowing within the patient.

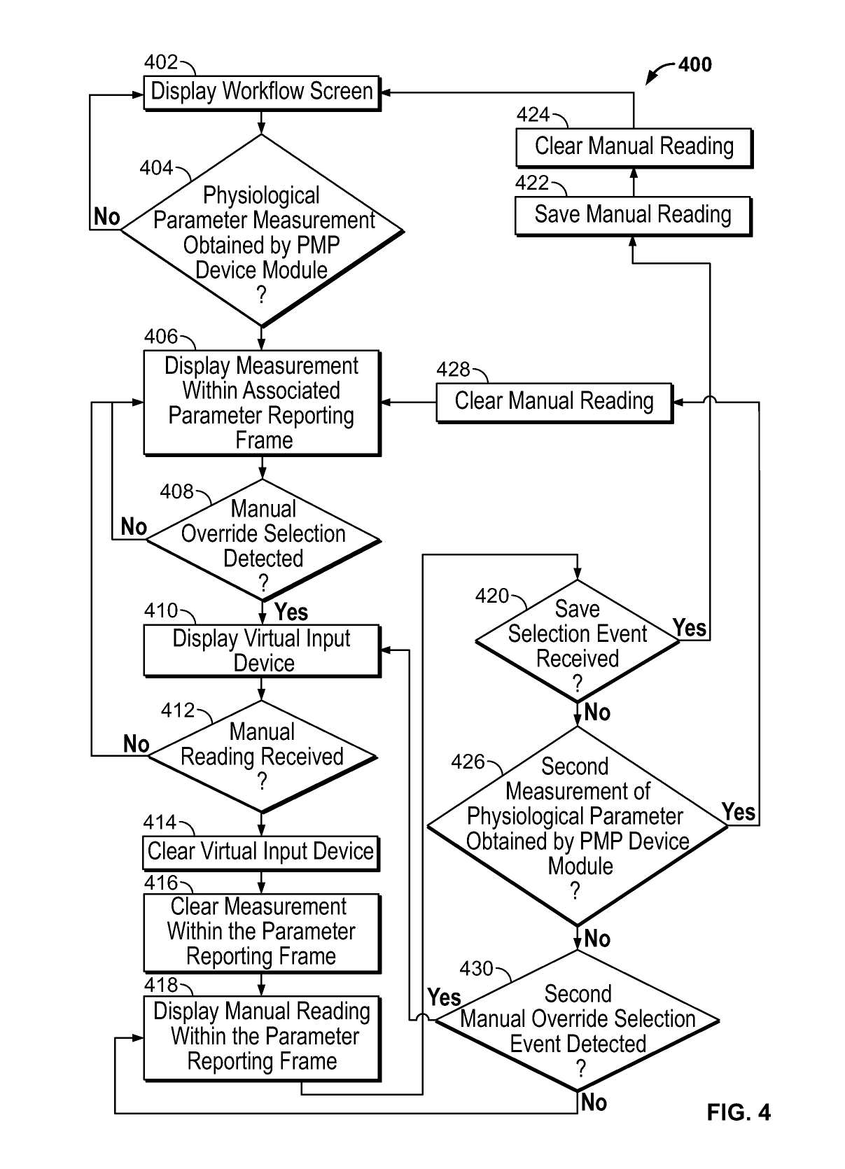

FIG. 2B is a schematic, perspective view of the PMP device 200 of FIG. 2A, illustrating an example user interface displayed on the display screen 218 of the PMP device 200. The touch-sensitive display screen 218 is configured not only to display representations of physiological parameters obtained via the HCE modules installed in the PMP device 200, but to receive a manual override selection through the user interface by a user who wants to clear a particular representation of a physiological parameter automatically obtained by the PMP device 200 and enter a new measurement obtained from a different source or instrument than the HCE modules of the PMP device 200. Such a manual override selection is described below in further detail with reference to FIGS. 4-11.

The PMP device 200 is configured to be able to measure different types of physiological parameters. In some embodiments, physiological parameters are categorized as either episodic parameters or continuous parameters.

The continuous parameters are physiological parameters continuously monitored from a single patient over a period of time. Accordingly, the continuous parameters have continuous profiles. Examples of the representation of the continuous parameters include a plethysmographic waveform view of the parameters.

The episodic parameters are physiological parameters that have either spot profiles or intervals profiles. A physiological parameter can have a spot profile when the PMP device 200 obtains a measurement of a physiological parameter from a patient at an isolated incident. For example, when the PMP device 200 operates in a spot check operation, the PMP device 200 obtains blood pressure measurements from a series of previously-identified patients. As used in this document, a patient is a previously identified patient when the PMP device 200 stores information regarding the identity of the patient. When the PMP device 200 is operating in a triage operation, the PMP device 200 can obtain a single blood pressure measurement from each patient in a series of unidentified patients as the patients arrive at a hospital. As used in this document, a patient is an unidentified patient when the PMP device 200 does not store information regarding the identity of the patient.

A physiological parameter has an intervals profile when the PMP device 200 obtains a series of discrete measurements of the parameter of a single patient, which is monitored at intervals over a period of time. For example, the PMP device 200 can obtain a temperature measurement of a single patient once every ten minutes for six hours. In this case, the PMP device 200 displays a representation of the patient's body temperature based on a most recent one of the temperature measurements.

Examples of episodic parameters include, but not limited to, NIBP and body temperature. Examples of continuous parameters include, but not limited to, SpO2, EtCO2, respiratory rate and pulse rate.

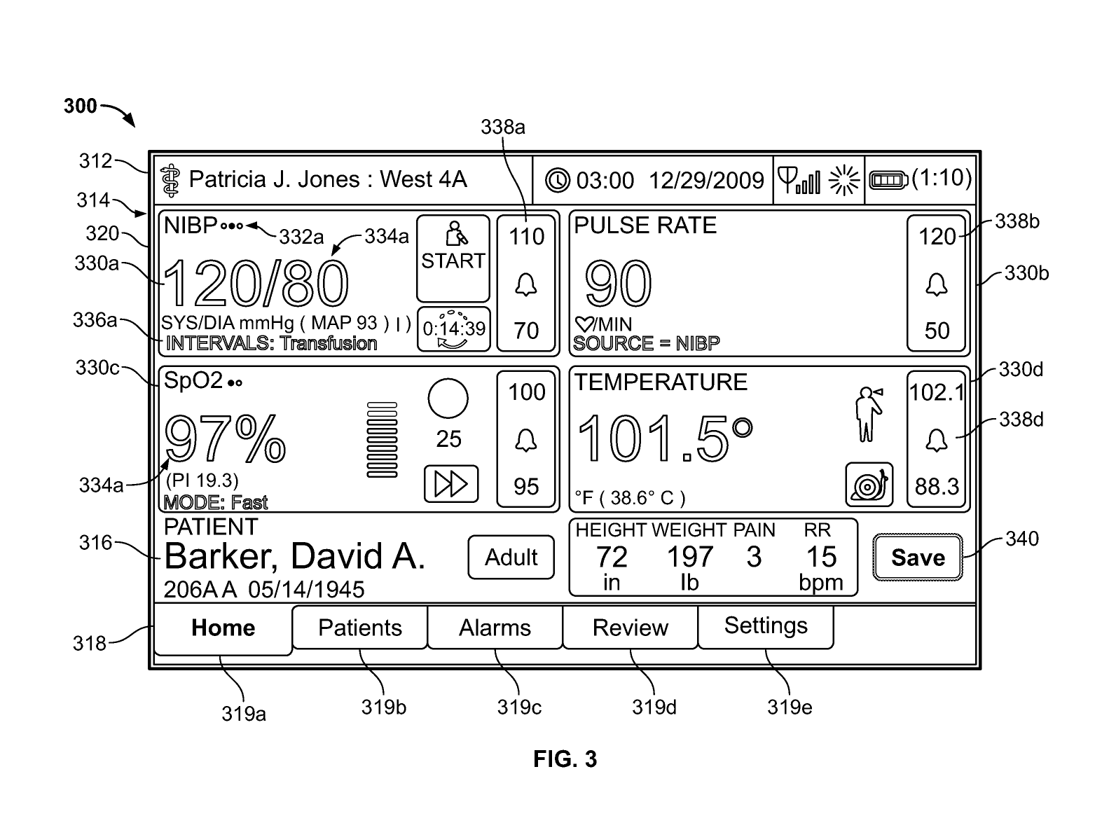

FIG. 3 is a schematic view of an example workflow screen 300. In some embodiments, the workflow screen 300 is displayed on the display screen 218 of the PMP device 200. The workflow screen 300 is designed for displaying representations of measurements of physiological parameters associated with a patient. In some embodiments, as described above, such measurements of physiological parameters are obtained by one or more HCE modules installed in the PMP device 200. In other embodiments, the workflow screen 300 is also configured to display measurements of physiological parameters that are acquired from different instruments or sources from the HCE modules associated with the PMP device 200.

In some embodiments, the workflow screen 300 includes a device status area 312, a navigation area 318 and a content area 320. The content area 320 is divided into a parameter reporting area 314 and a patient attribute area 316. In other embodiments, the workflow screen 300 further includes a save selection button 340.

The device status area 312 contains data regarding a status of the PMP device 200. In this example, the device status area 312 includes text that identifies a clinician (“Patricia J. Jones”) and a health care facility location (“West 4A”). A current time of day value (“03:00”) is located to the right side of the time of day value. A remaining time of a batter value (“1:10”) is located at the right side of the device status area 312.

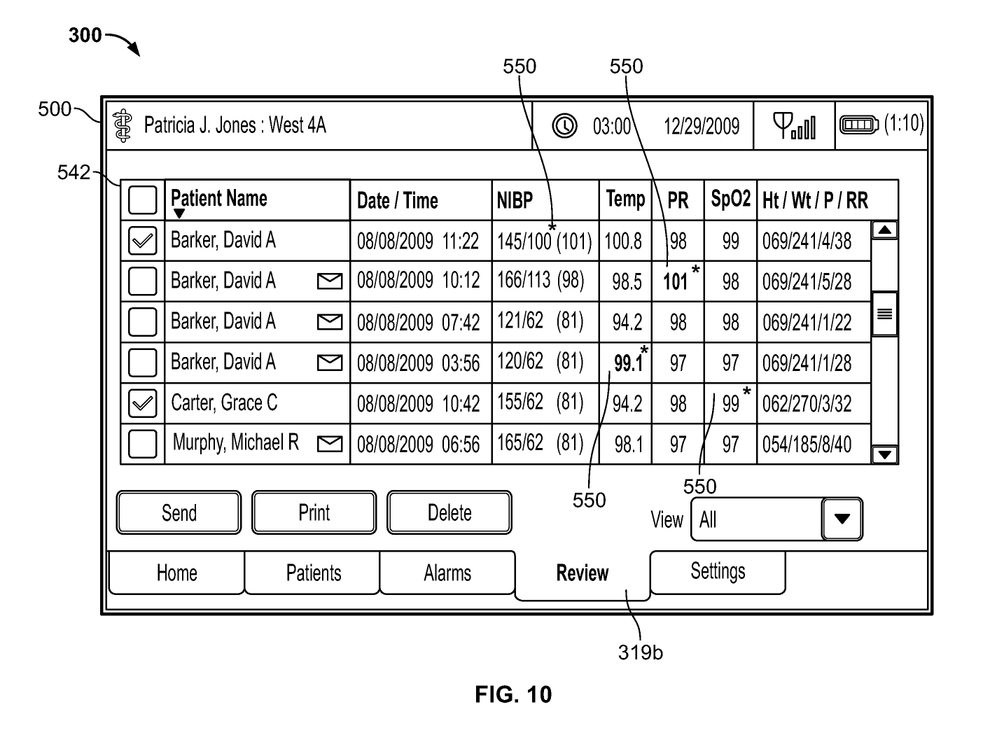

The navigation area 318 includes screen tabs 319, such as a home tab 319a, a patients tab 319b, an alarms tab 319c, a review tab 319d, and a settings tab 319e. In some embodiments, the workflow screen 300 is displayed on the screen 218 when the home tab 319a is selected. Selection of other screen tabs 319b-319e causes substitution of the workflow screen 300 with another screen associated with the screen tabs 319b-319e. For example, the PMP device 200 displays a review screen when a user selects the review tab 319d. FIG. 10, discussed elsewhere in this document, illustrates an example review screen. The PMP device 200 also displays an alarm screen when a user selects the alarms tab 319c. Furthermore, the PMP device 200 displays a patient screen when a user selects the patients tab 319b, and a settings screen when a user selects the settings tab 319e. When the PMP device 200 displays a screen other than the workflow screen 300 and a user selects the home tabs 31a, the PMP device 200 displays the workflow screen 300.

The parameter reporting area 314 includes one or more parameter reporting frames 330. Each of the parameter reporting frames 330 contains a representation of a different physiological parameter associated with a patient. The representations are based on one or more measurements of the physiological parameters of a monitored patient.

In some embodiments, the PMP device 200 enables a user to customize the parameter reporting frames 330 within the workflow screen 300. For example, the PMP device 200 enables the user to select particular parameter reporting frames 330 that will be displayed within the workflow screen 300. The user can also add, remove, or switch, parameter reporting frames on the workflow screen 300, as necessary.

In some embodiments, each parameter reporting frame 330 includes a parameter name field 332, a measurements field 334, an extended label field 336, and an alarm status field 338.

The parameter name field 332 (including 332a, 332b, 332c and 332d) is configured to display the name or title of the parameter associated with a monitored patient. In some embodiments, the parameter name fields 332 are located at an upper left portion of the parameter reporting frames 330, respectively. In the example of FIG. 3, the parameter reporting area 314 has four parameter reporting frames 330, such as a NIBP frame 330a, a pulse rate frame 330b, a SpO2 frame 330c, and a temperature frame 330d. The NIBP frame 330a has the parameter name field 332a that indicates the parameter “NIBP.” The pulse rate frame 330b has the parameter name field 332b that shows the parameter “PULSE RATE.” The SpO2 frame 330c has the parameter name field 332c that identifies the parameter “SpO2.” The temperature frame 330d has the parameter name field 332d that indicates the parameter “TEMPERATURE.”

The measurements field 334 (including 334a, 334b, 334c and 334d) is configured to display a representation of an associated parameter of a monitored patient. The representation of the parameter associated with the patient is based on one or more measurements of the parameter of the patient. In various embodiments, the measurements field 334 contains various representations of the parameter of the patient.

In the example of FIG. 3, the NIBP frame 330a has the measurement field 334a that includes enlarged numerical text that represents a systolic blood pressure value (“120”) and a diastolic blood pressure value (“80”), separated from each other via a slash ‘/’ text character. The systolic blood pressure value is located at the left side of the NIBP frame 330a and the diastolic blood pressure is located to the right side of the systolic blood pressure value. The pulse rate frame 330b has the measurement field 334b that includes enlarged numerical text that represents a pulse rate value (“90”). The pulse rate value (“90”) is located at the left side of the pulse rate frame 330b. The SpO2 frame 330c has the measurement field 334c that includes enlarged numerical text representing an SpO2 value (“97%”). The SpO2 value (“97%”) is located at the left side of the SpO2 frame 330c and is accompanied by a ‘%’ text character on the right side of the SpO2 value. The temperature frame 330d has the measurement field 334d that includes enlarged numerical text representing a temperature value (“101.5”). The temperature value (“101.5”) is located at the left side of the temperature frame 330d and is accompanied by a Fahrenheit degree indicating symbol on the right side of the temperature value.

The extended label field 336 (including 336a, 336b, 336c and 336d) is designed for displaying various pieces of information regarding an associated parameter. In some embodiments, the extended label field 336 displays a source of measurements of the parameter associated with a monitored patient. In the example of FIG. 3, the extended label field 326a of the NIBP frame 330a represents that the blood pressure of a patient is monitored and measured with an interval program called “Transfusion.” For example, during an interval program, the PMP device 200 records measurements of one or more physiological parameters of a patient at a selected interval for a predetermined length of time. The PMP device enables a user to define such an interval and length of time as necessary. In FIG. 3, the extended label field 336b of the pulse rate frame 330b indicates a source of the pulse rate, displaying the (“SOURCE=NIBP”) text.

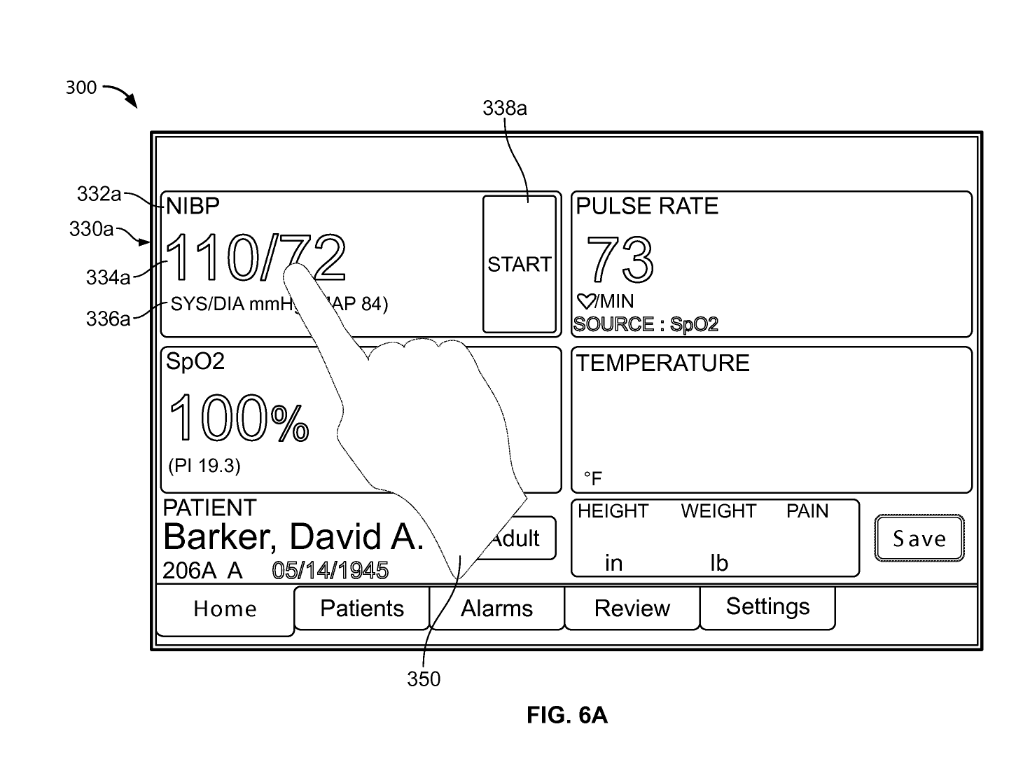

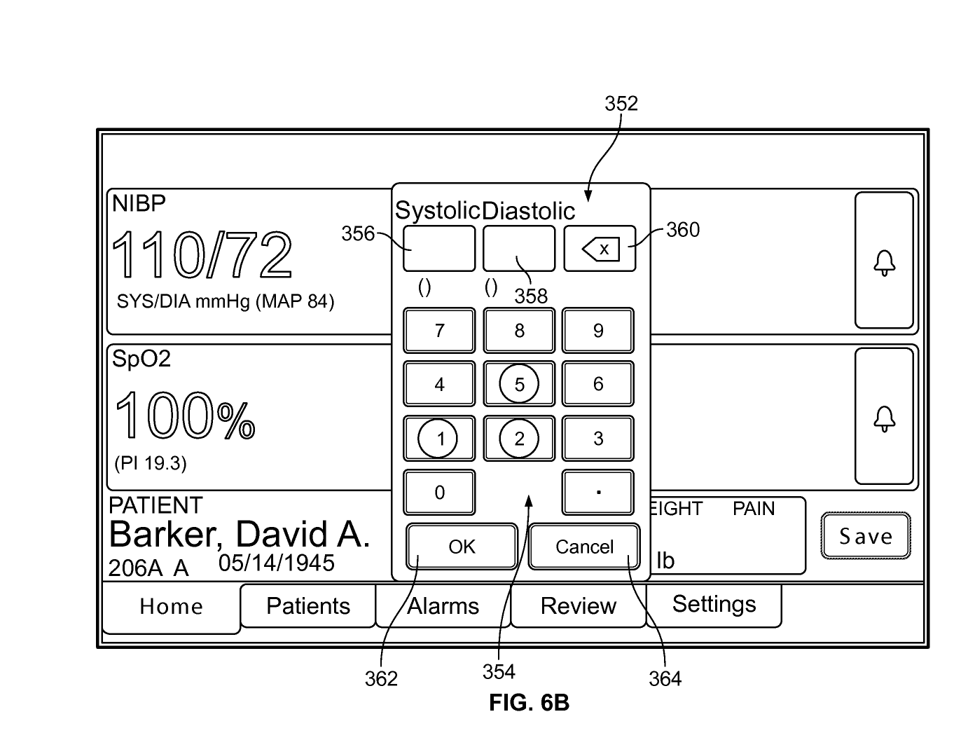

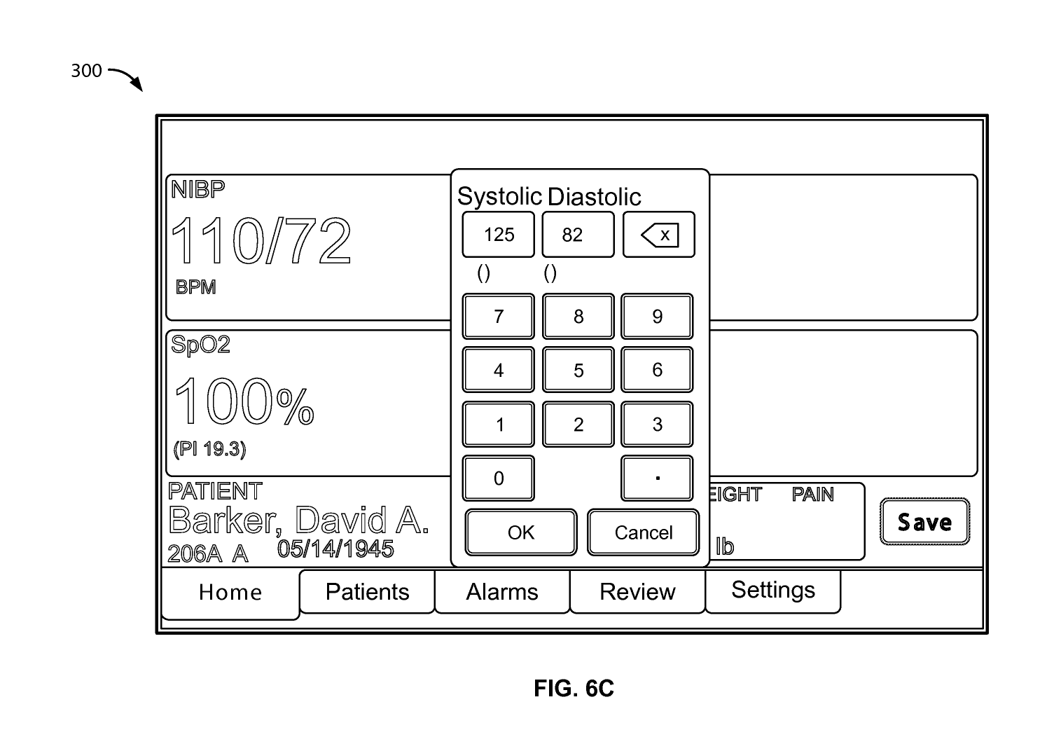

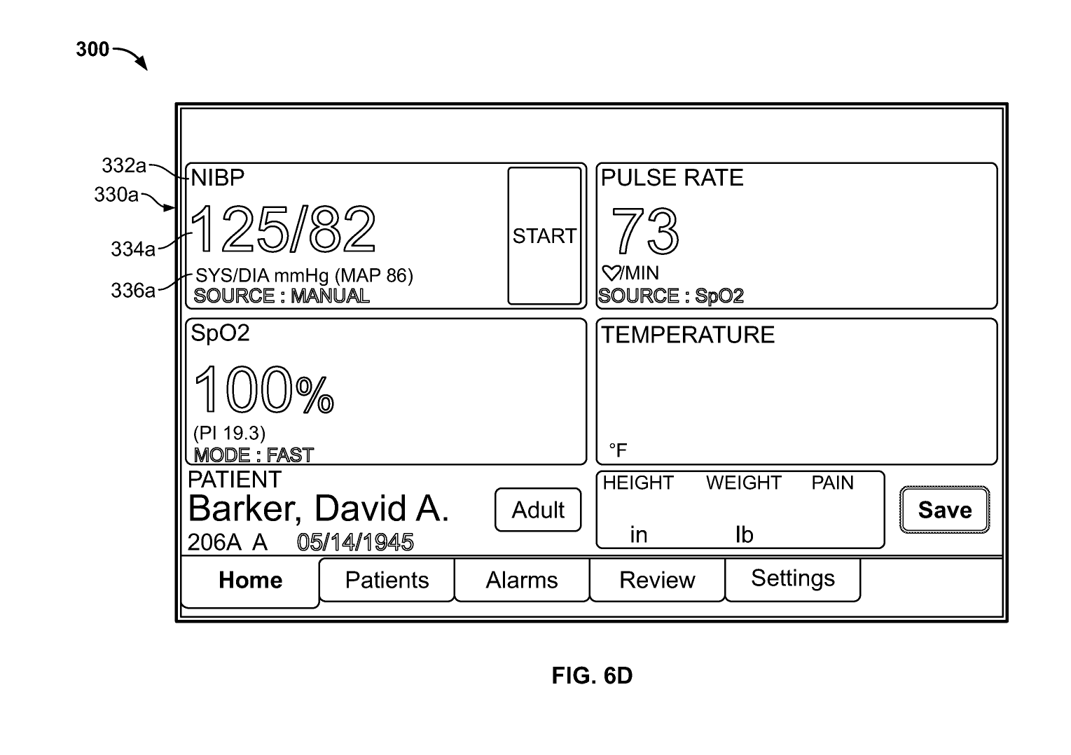

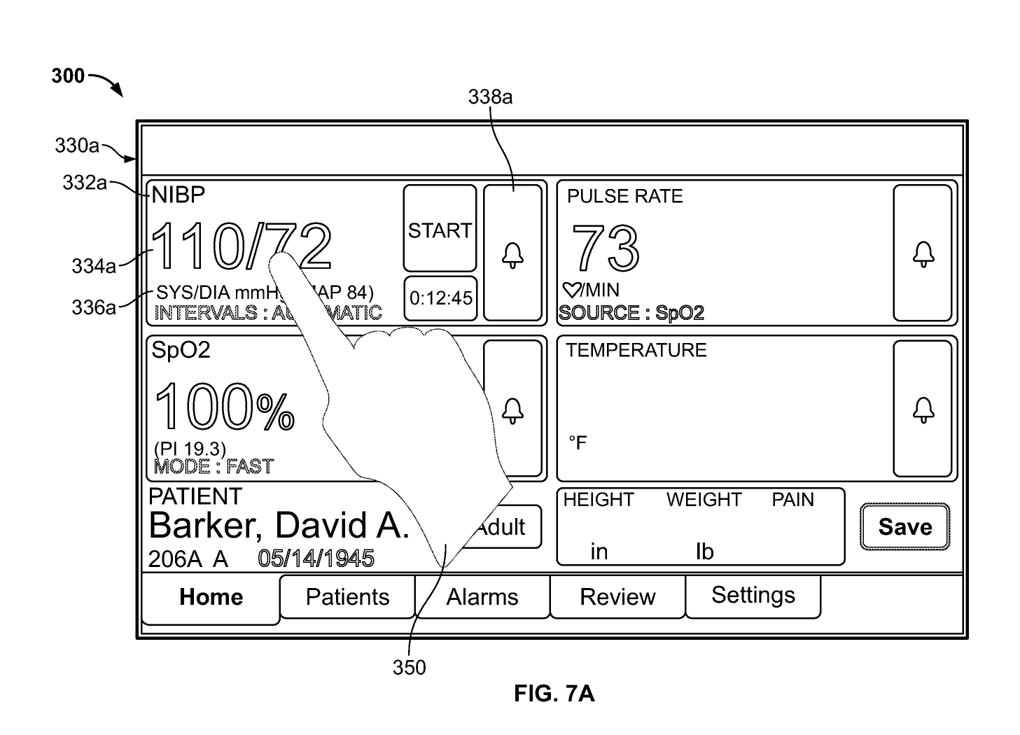

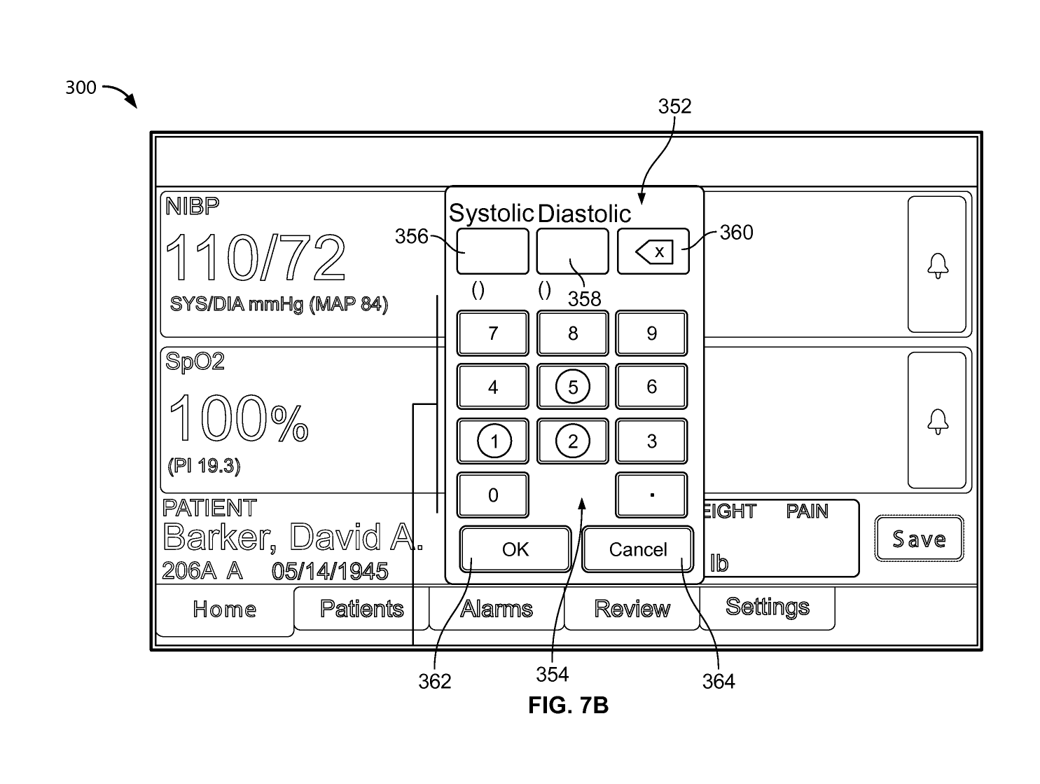

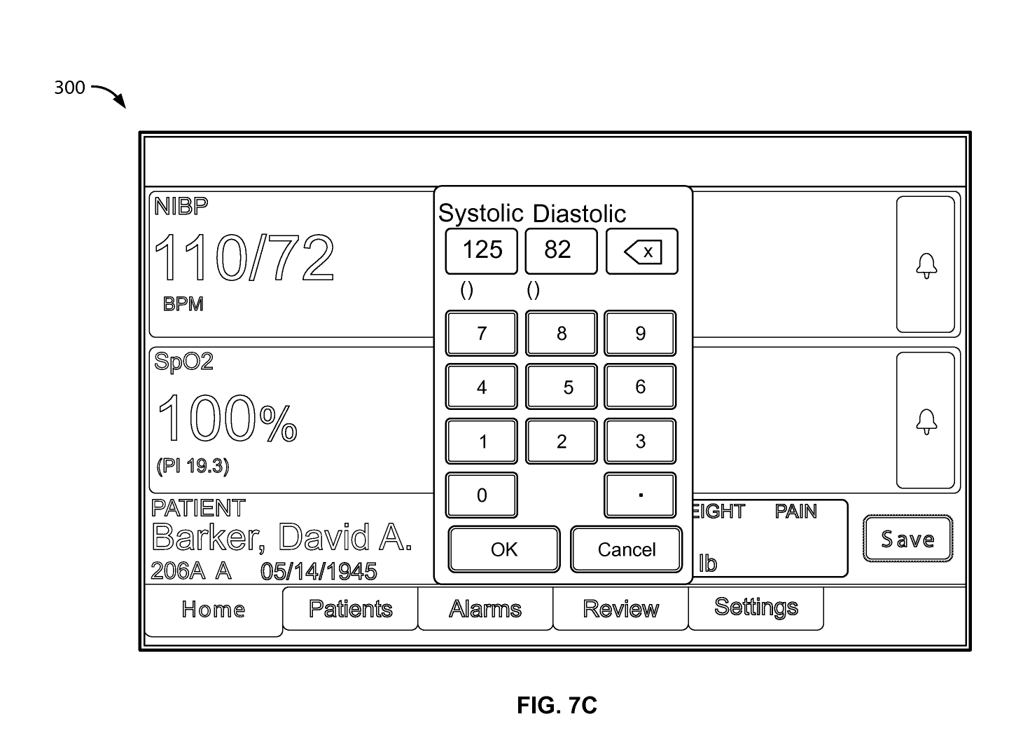

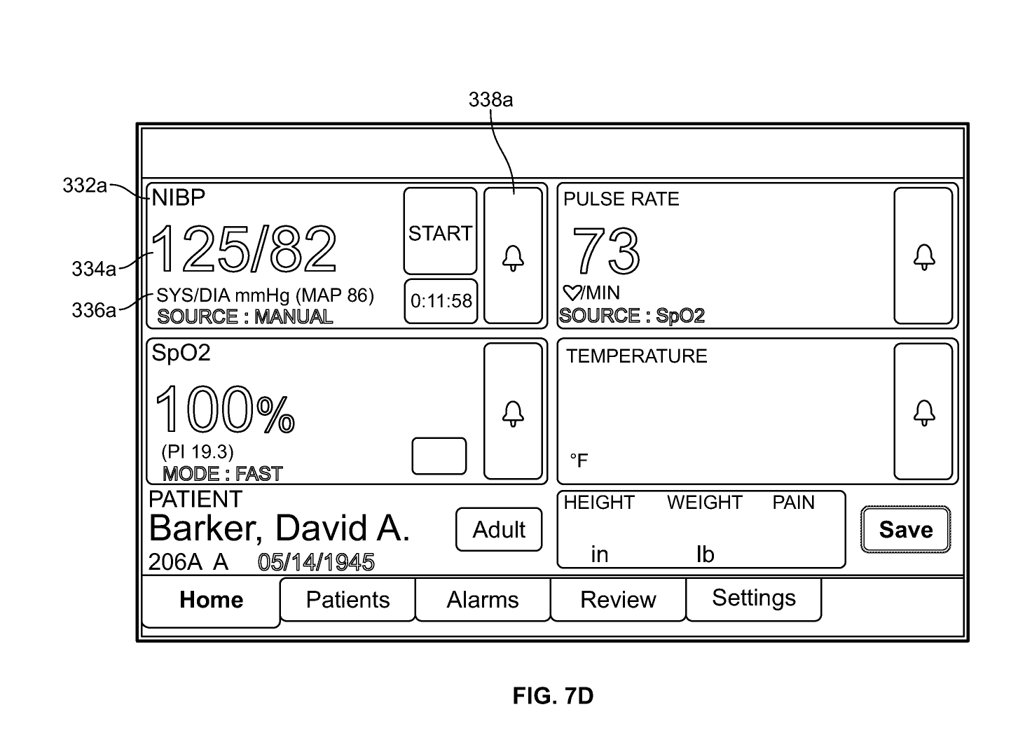

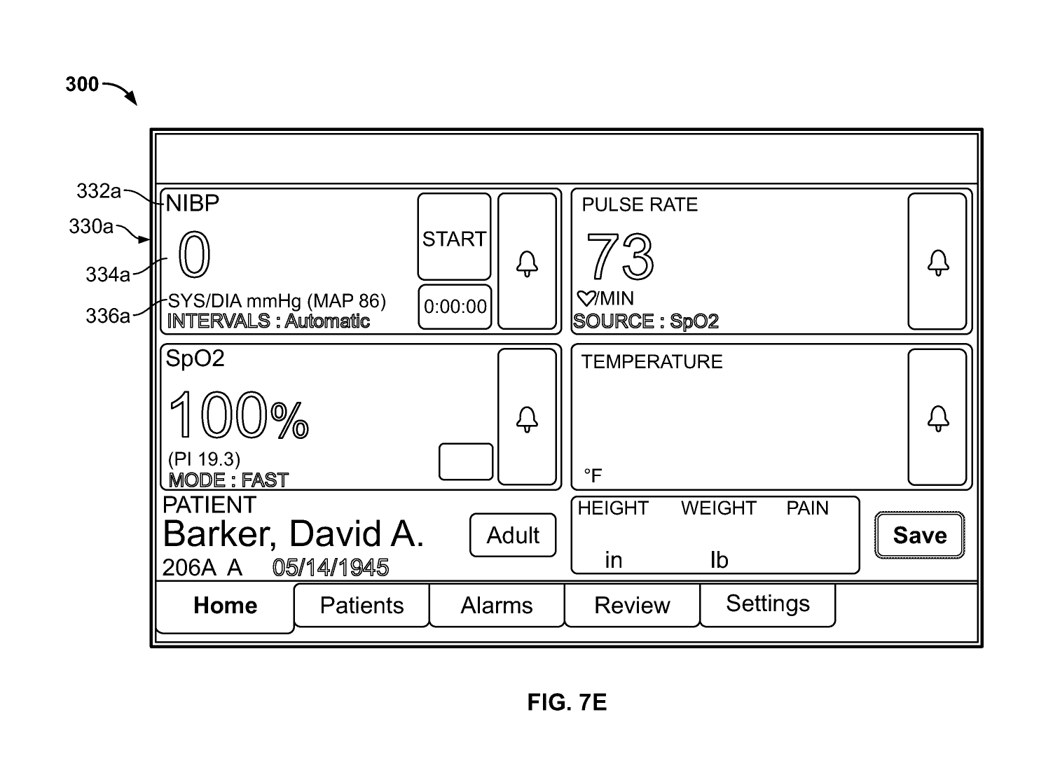

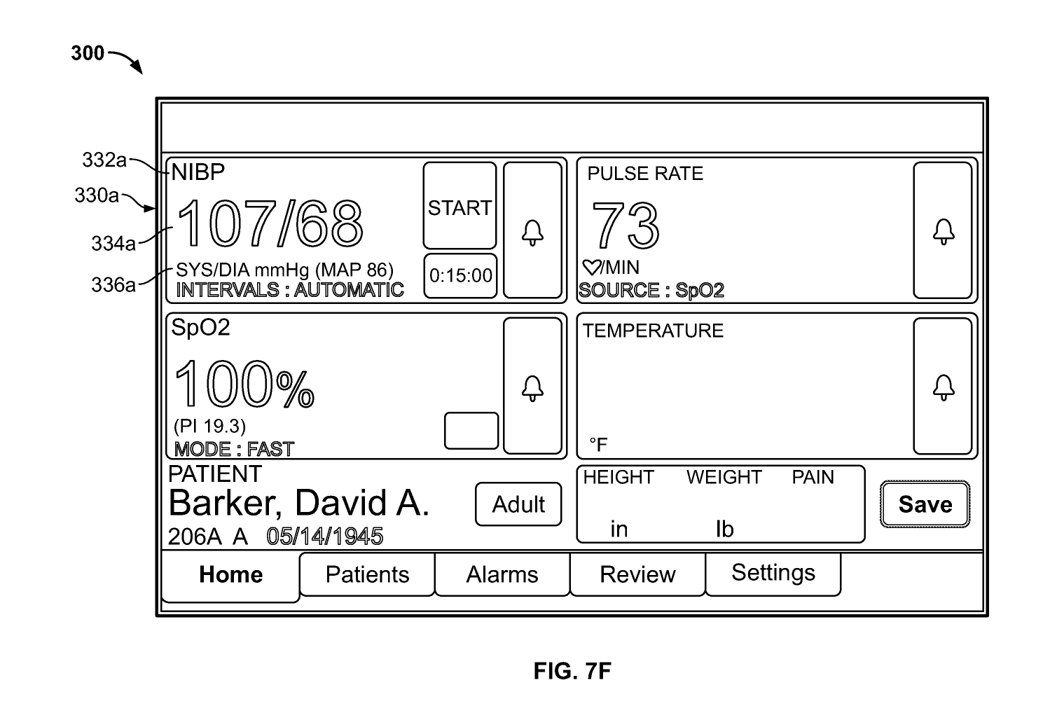

In some embodiments, the extended label field 336 can represent either that a measurement of a physiological parameter displayed within the measurement field 334 has been obtained by a HCE module installed in the PMP device 200, or that it has been acquired from an instrument or source different from the HCE modules of the PMP device 200. For example, when a physiological parameter is obtained by a HCE module of the PMP device 200, the source of the parameter can be labeled with the text “Automatic” (as shown in FIG. 7A). When the physiological parameter is overridden by a separate reading acquired by an instrument other than the HCE modules of the PMP device 200, the source can be labeled with the text “Manual” (as shown in FIG. 6D). Overriding of a physiological parameter is explained in further detail with reference to FIGS. 4-11.

In some embodiments, the parameter reporting frames 330 can contain the alarm status fields 338 (including 338a, 338b, 338c and 338d), respectively. Each alarm status field 338 is designed to specify an upper alarm limit and a lower alarm limit for an associated physiological parameter of a monitored patient. In this example, the alarm status fields 338 are located at the right side of the parameter reporting frames 330.

In the example of FIG. 3, the alarm status field 338a of the NIBP frame 330a specifies an upper alarm limit and a lower alarm limit for the patient's systolic blood pressure and an upper alarm limit and a lower alarm limit for the patient's diastolic blood pressure. The upper alarm limit and the lower alarm limit for the patient's systolic blood pressure define a systolic blood pressure alarm range. The upper alarm limit and the lower alarm limit for the patient's diastolic blood pressure define a diastolic blood pressure alarm range. An alarm associated with the patient's blood pressure is active when the patient's systolic blood pressure is outside the systolic blood pressure alarm range or when the patient's diastolic blood pressure is outside the diastolic blood pressure alarm range. The alarm status field 338b of the pulse rate frame 330b specifies an upper alarm limit and a lower alarm limit. The upper alarm limit and the lower alarm limit define a pulse rate alarm range. An alarm associated with the patient's pulse rate is active when the patient's pulse rate is outside the pulse rate alarm range.

The alarm status field 338c of the SpO2 frame 330c specifies an upper alarm limit and a lower alarm limit. The upper alarm limit and the lower alarm limit define a SpO2 alarm range. An alarm associated with the patient's SpO2 level is active when the patient's SpO2 level is outside the SpO2 alarm range for a predetermined duration of time.

The alarm status field 338d of the temperature frame 330d specifies an upper alarm limit and a lower alarm limit. The upper alarm limit and the lower alarm limit define a temperature alarm range. An alarm associated with the patient's temperature is active when the patient's temperature level is outside the temperature alarm range.

In other embodiments, the alarm status field 338 disappears from the parameter reporting frame 330 for certain physiological parameters. For example, when the PMP device 200 operates in the spot check operation, the NIBP frame 330a does not contain the alarm status field 338a, as shown in FIGS. 6A-6D, which would otherwise be displayed in the NIBP frame 330a.

An activation of an alarm can be implemented in various ways, such as visual indication and sound indication. For example, when an alarm is active with respect to a particular physiological parameter, a perimeter around the parameter reporting frame for the particular physiological parameter transitions from a gray color to a red color. Changing the color of the perimeter provides a visual indication that the alarm is active. In some embodiments, the perimeter around the parameter reporting frame also flashes, thereby providing another visual indication that the alarm is active. Furthermore, a bell-shaped symbol within the alarm status area can change its color when the alarm is active.

In some embodiments, when an alarm associated with a particular physiological parameter is active, the PMP device 200 causes the device status area 312 to display an alarm message that visually indicates that an alarm is active and indicates a brief description of the alert. In other embodiments, when an alarm associated with a particular physiological parameter is active, the PMP device 200 emits an alarm sound. The PMP device 200 continues to emit the alarm sound until the alarm is deactivated or until a user temporarily silences the alarm sound. When the user temporarily silences the alarm sound, the PMP device 200 suspends emitting the alarm sound for a given time period. In various embodiments, the user is able to temporarily silence the alarm sound in various ways.

The PMP device 200 enables a user to customize or configure alarm settings in various ways. In some embodiments, a user can control alarm settings that apply to all alarms provided by the PMP device 200, such as resetting all alarm limits, displaying alarm limits on the touch-sensitive display screen 218, emitting alarm sounds, setting volume of the alarm sounds, and muting alarm sounds. In other embodiments, the PMP device 200 enables a user to configure parameter-specific alarm setting. For example, the user can turn on/off an alarm for a particular parameter and set an upper limit and/or a lower limit for the alarm for the parameter.

The workflow screen 300 can further include a save selection button 340. In the example of FIG. 3, the save selection button 340 is labeled as “Save” at the lower right side of the workflow screen 300. When a user clicks the save selection button 340, the PMP device 200 operates to store all of the information or values represented in the workflow screen 300 into the PMP device 200 or any other appropriate storage, such as a host system and an electronic medical records (EMR) system. In some embodiments, the save selection button 340 is configured to operate to selectively store some pieces of information or values represented in the workflow screen 300.

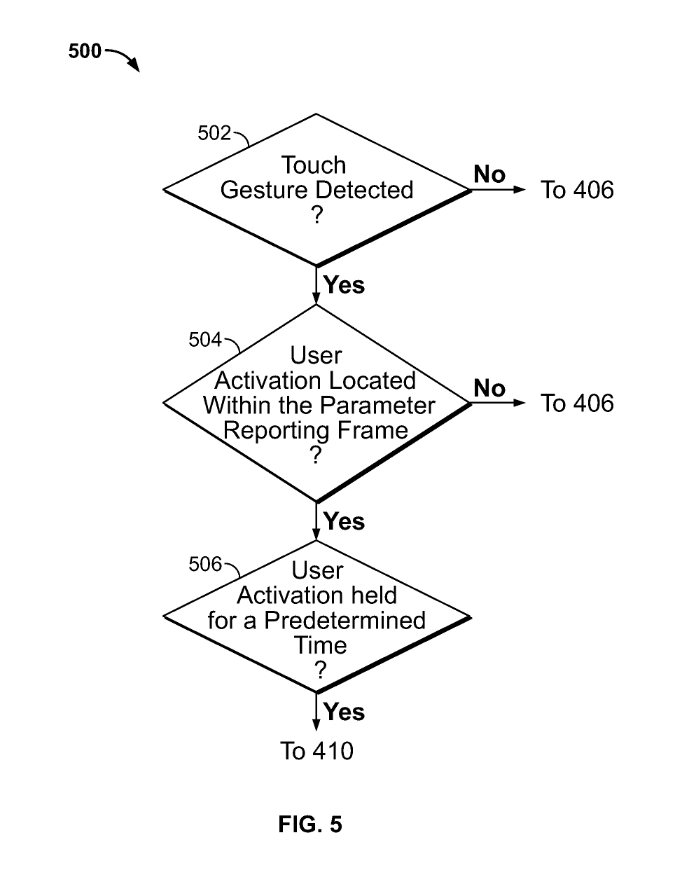

In some embodiments, the PMP device 200 saves the information or values represented in the workflow screen 300 into local non-volatile storage within the PMP device 200. The information or values include measurements of the physiological parameters of the patient. In some embodiments, the information or values also include data indicating attributes of the patient. A user can use the review screen 500 (FIG. 10) to review the saved information or values. Furthermore, the PMP device 200 automatically attempts to transmit the saved information or values to another computing node, which is user-configurable through, for example, the settings screen. In some embodiments, the other computing node is an EMR system. Optionally, the other computing node is the interface system 104. Instead of the automatic transmission of the saved information or values, in other embodiments, a user can navigates to the review screen 500 (FIG. 5) and manually select the patient reading that the user wants to send. The PMP device 200 can be configured to continue to display the workflow screen 300 when the save selection button 340 is selected.

FIGS. 4-11 illustrate an example operation of the PMP device 200. The PMP device 200 is configured not only to measure physiological parameters via the HCE modules installed in the PMP device 200 and display representations of the parameters on the touch-sensitive display screen 218, but also to receive a manual override selection through the touch-sensitive display screen 218. The manual override selection is an input by a user who wants to clear a particular representation of a physiological parameter automatically obtained by the PMP device 200 and enter a new measurement obtained from a different source or instrument than the HCE modules of the PMP device 200.

In this example, the touch-sensitive display screen 218 is employed to operate both to display representations of the parameters and to receive manual override selections. However, in some embodiments, the PMP device 200 can have an input device for receiving manual override selections, which is separate from a display device for displaying representations of the parameters. Such an input device can be incorporated or mounted to the PMP device 200. Alternatively, the input device can be an external device that is adapted to be connected to the PMP device 200, either wired or wirelessly. Non-limiting examples of the input device include analog control knobs and physical keyboards or keypads.

As described above, the PMP device 200 operates to measure physiological parameters from a monitored patient with the HCE modules installed to the PMP device 200 and to display representations of the measurement of physiological parameters on the display screen 218. For example, the PMP device 200 operates to display representations of the physiological parameters obtained via the HCE modules within the parameter reporting frames 330 of the workflow screen 300. In this document, such representations of physiological parameters measured by the HCE modules of the PMP device 200 are referred to as “automated readings” or “device-measured readings.”

In addition to automated readings, the PMP device 200 can also operate to receive a manual input of physiological parameter measurements and display the manual input on the display screen 218. In some embodiments, the PMP device 200 is configured to allow a clinician to manually enter measurements of physiological parameters onto the touch-sensitive display screen 218 and override automated readings of the physiological parameters displayed on the touch-sensitive display screen 218. In this document, such measurements of physiological parameters manually input by users are referred to as “manual readings” or “manual inputs.” In some embodiments, manual readings are obtained from an instrument or source other than the PMP device 200. In some embodiments, the PMP device 200 operates to allow users to replace automated readings with manual readings on the touch-sensitive display screen 218. For example, when an automated reading displayed on the display screen 218 is suspicious, a clinician can choose to acquire a reading from an alternate instrument or source in order to make sure that the automated reading is accurate. If the automated reading turns out to be incorrect, the clinician can enter the manual reading obtained from the alternate instrument or source through the touch-sensitive display screen 218 by overriding the automated reading with the manual reading. This manual input or override operation of physiological parameters allows the clinician to conveniently document manual readings of physiological parameters via the PMP device 200 at the point of care. Accordingly, the PMP device 200 with the manual input or override function can eliminate additional steps that a clinician would otherwise have to take, such as access to a host system or EMR, to document manual readings from an alternate source at the host system or EMR.

FIG. 4 is a flowchart illustrating an example operation 400 performed by the PMP device 200 for obtaining and overriding measurements of an episodic parameter with a spot profile, such as NIBP and temperature. In this example, the operation 400 generally begins when the PMP device 200 displays the workflow screen 300 (402). The PMP device 200 then determines whether a physiological parameter has been measured by any of the HCE modules installed in the PMP device 200 (404). If the PMP device 200 determines that a measurement of the physiological parameter was not obtained via the HCE module, the PMP device 200 does not change anything in the workflow screen 300 and continues to display the workflow screen 300 (402).

If the PMP device 200 determines that a measurement of the physiological parameter has been acquired via the HCE module, the PMP device 200 displays the measurement within a parameter reporting frame 330 of the workflow screen 300 that is associated with the parameter (406). For example, the measurement of the physiological parameter acquired by the HCE module can be represented on the measurements field 333 of the parameter reporting frame 330 associated with the parameter.

Since the physiological parameter acquired via the HCE module of the PMP device 200 is an episodic parameter with a spot profile, the PMP device 200 is configured to measure, and display, the parameter at discrete incidents. For example, where a clinician configures the PMP device 200 to operate in a spot check operation, the clinician uses the HCE modules of the PMP device 200 only when the clinician wants to measure the parameter from a patient. In this case, the PMP device 200 is configured to update a representation of the measurement of the episodic parameter displayed on the parameter reporting frame 330 only when a new measurement of the parameter is acquired via the HCE module by the clinician.

When the physiological parameter acquired via the HCE module of the PMP device 200 is an episodic parameter with an intervals profile, the PMP device 200 is configured to measure the parameter at a predetermined interval and update representations of the measurements displayed on the parameter reporting frame 330 at the same interval. For example, where a clinician configures the PMP device 200 to operate to measure a physiological parameter, such as NIBP or temperature, via a HCE module at a predetermined interval, the PMP device 200 updates a representation of the measurement of the parameter displayed on the parameter reporting frame 330 at the same interval. In some embodiments, such intervals are also configurable in the PMP device 200 by users.

Next, the PMP device 200 determines whether a manual override selection has been detected on the touch-sensitive display screen 218 (408). The manual override selection is a request by a user for inputting a manual reading, which has been acquired from an instrument or source different from the HCE modules installed in the PMP device 200, into the PMP device 200 and replacing an automated readings obtained by the HCE modules of the PMP device with the manual reading. In some embodiments, the manual override selection is defined by a user who interacts with the touch-sensitive display screen 218 in a predetermined manner. The PMP device 200 is configured to detect the manual override selection when a user interacts with the touch-sensitive display screen 218 in such a predetermined manner.

If the PMP device 200 determines that the manual override selection is detected from the touch-sensitive display screen 218 (“YES” of 408), the PMP device 200 displays a virtual input device (410). In some embodiments, the virtual input device is a numerical keypad that enables a user to manually enter a value for a manual reading for the parameter. In some embodiments, the virtual input device appears within the workflow screen 300 by at least partially overlapping the parameter reporting frames 330 of the workflow screen 300. In other embodiments, the virtual input device appears on the touch-sensitive display screen 218 without overlapping parameter reporting frames 330 of the workflow screen 300.

When the PMP device 200 displays the virtual input device and a user manually enter a value for a manual reading, the PMP device 200 determines whether the manual reading is received (412). The PMP device 200 is configured to determine that the manual reading has been received when the user finalizes the value that the user has typed in on the virtual input device on the touch-sensitive display screen 218. In some embodiments, the virtual input device contains an “OK” button. When the user clicks the “OK” button after typing in a value for a manual reading, the PMP device 200 determines that the user has finalized input of the manual reading and receives the manual reading.

Once the PMP device 200 receives the manual reading of the parameter (“YES” of 412), the PMP device 200 operates to display a representation of the manual reading on the touch-sensitive display screen 218 by replacing the representation of the automated reading previously acquired by the HCE module of the PMP device 200 with the representation of the manual reading of the parameter. For example, when the PMP device 200 receives the manual reading of the parameter (“YES” of 412), the PMP device 200 operates to clear the virtual input device from the touch-sensitive display screen 218 (414). Subsequently, the PMP device 200 also operates to remove the representation of the previous measurement, which is the automated reading acquired by the HCE module of the PMP device 200, from the associated parameter reporting frame 330 (410). Then, the PMP device 200 operates to display the manual reading within the parameter reporting frame 330 (418). In some embodiments, the PMP device 200 is configured to display the manual reading of the parameter by replacing the representation of the previous measurement of the parameter with the manual reading of the parameter.

In some embodiments, the PMP device 200 is also configured to display a source representation when the manual reading of the parameter is displayed on the parameter reporting frame 330 at block 418. Such a source representation is arranged to indicate that the measurement of a physiological parameter displayed on the parameter reporting frame 330 is either an automated reading or a manual reading for the parameter. The source representation can be located adjacent to the associated manual reading and designed to show that the associated manual reading has been acquired by a user from an alternative instrument unassociated with the PMP device 200. For example, the source representation is represented within the extended label field 336 while the reading for the parameter is displayed within the corresponding measurements field 334. When a measurement for the parameter is an automated reading, the source representation can display the text “Automatic.” When the measurement for the parameter is a manual reading, the source representation can display the text “Manual.” One example of the source representation is explained below in further detail with reference to FIGS. 6A-6D.

The PMP device 200 continues to display the manual reading for the parameter on the touch-sensitive display screen 218 until a user selects to save the manual reading. After the PMP device 200 starts displaying the manual reading of the parameter (418), the PMP device 200 determines whether a save selection by a user is detected (420). In some embodiments, the workflow screen 300 contains a “SAVE” button. For example, when a user clicks the “SAVE” button on the workflow screen 300, the PMP device 200 operates to save measurements of the parameter displayed within the parameter reporting frames 330 on the touch-sensitive display screen 218. Such measurements of the parameter are stored into the PMP device 200. In other embodiments, the measurements are also stored, either automatically or by a user's request, in a host system or EMR system, or both, as necessary, when they are stored in the PMP device 200.

When the PMP device 200 determines that a save selection by a user is detected from the touch-sensitive display screen 218 (for example, when the PMP device 200 detects that the user has touched the “SAVE” button of the workflow screen 300) (“YES” of 420), the PMP device 200 operates to save the manual reading of the parameter into an appropriate place (either the PMP device or a host system, or both) (422). Subsequently, the PMP device 200 operates to remove the representation of the manual reading of the parameter from the associated parameter reporting frame 330 of the workflow screen 300 (424), and display the workflow screen 300 on the touch-sensitive display screen 218, leaving blank the measurements field 334 of the parameter reporting frame 330 (402). In other embodiments, even after the manual reading is saved in response to the save selection by the user, the representation of the manual reading of the parameter can remain on the parameter reporting frame 330 until a subsequent event occurs.

When the PMP device 200 determines that a save selection by a user is not detected from the touch-sensitive display screen 218 (“NO” of 420), the PMP device 200 determines whether the HCE module of the PMP device 200 has obtained another measurement of the parameter from the patient (426). When the parameter is an episodic parameter with intervals profile, a subsequent measurement of the parameter will be acquired via the HCE module of the PMP device 200 after a predetermined period of time since the PMP device 200 displays the manual reading of the parameter as described above. If the parameter is an episodic parameter with spot profile, a next measurement of the parameter will be obtained via the HCE module of the PMP device 200 when a user wants to acquire such a measurement of the parameter from a patient.

If the PMP device 200 determines that another measurement of the parameter is obtained via the HCE module of the PMP device 200 (“YES” of 426), the PMP device 200 operates to display a representation of the other measurement of the parameter just obtained by the PMP device 200 on the touch-sensitive display screen 218 by replacing the representation of the manual reading of the parameter with the new representation of the parameter. In some embodiments, if the PMP device 200 determines that a new measurement of the parameter has been obtained by the PMP device 200 (“YES” of 426), the PMP device 200 operates to remove the representation of the manual reading of the parameter (428) from the associated parameter reporting frame 330 and, subsequently, display the new automated reading within the parameter reporting frame 330 (for example, within the associated measurements field 334) on the touch-sensitive display screen 218 (406).

If the PMP device 200 determines that a new measurement of the parameter has not been acquired via the HCE module of the PMP device 200 (“NO” of 426), the PMP device 200 operates to determine whether a new manual override selection has been detected on the touch-sensitive display screen 218 (430). The operation of the PMP device at block 430 is the same as the operation at block 408. If the PMP device 200 determines that a new manual override selection is detected (“YES” of 430), the operation of the PMP device 200 returns to block 410 and displays the virtual input device (410). After that, the PMP device 200 repeats the same operations as described above with respect to blocks 412-430.

If the PMP device 200 determines that there is no new manual override selection detected from the touch-sensitive display screen 218 (“NO” of 430), the PMP device 200 continues to display the first manual reading of the parameter previously obtained from the manual override selection by the user against the touch-sensitive display screen 218 (418).

In some embodiments, the operations (420, 426 and 430) can be arranged in different orders. In other embodiments, some of the operations (420, 426 and 430) can be omitted from the entire operation of the PMP device 200. For example, when the PMP device 200 determines that a save selection was not detected from the touch-sensitive display screen 218 (“NO” of 420), the operation of the PMP device 200 can directly return to block 418 so that the PMP device 200 remains to display the manual reading of the parameter within the associated parameter reporting frame 330 (418). Similarly, when the PMP device 200 determines that a new measurement of the parameter is not obtained via the HCE module of the PMP device 200 (“NO” of 426), the operation of the PMP device 200 can directly return to block 418 so that the PMP device 200 continues to display the manual reading of the parameter within the associated parameter reporting frame 330 (418).

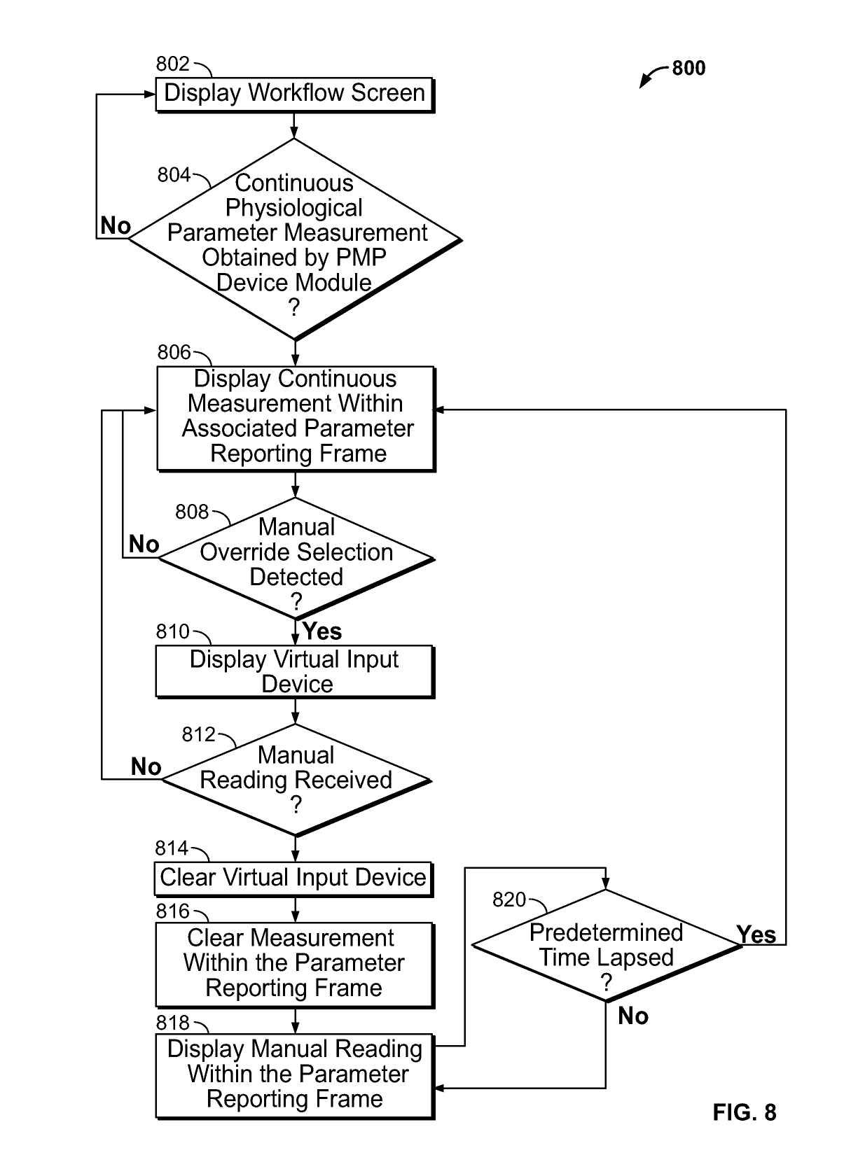

FIG. 5 is a flowchart illustrating an example operation 500 for detecting a manual override selection. In this example, the operation 500 applies to the operation 408. In some embodiments, the operation 500 can also apply to the operations 430 and 808 (FIG. 8) and any other operations similar to the operation 408. In this example, the manual override selection is conducted by a user who interacts with the touch-sensitive display screen 218.

For the operation 500 for detecting a manual override selection, the PMP device 200 first determines whether a user activation has been detected on the touch-sensitive display screen (502). In some embodiments, the user activation is defined as a touch gesture performed by a user against the surface of the touch-sensitive display screen 218.

If the PMP device 200 determines that the user activation was not detected on the touch-sensitive display screen 218, the operation of the PMP device 200 returns to block 406 where the PMP device 200 continues to display the automated reading within the associated parameter reporting frame 330 (406).

If the PMP device 200 detects the user activation against the touch-sensitive display screen 218 (“YES” of 502), the PMP device 200 then determines whether the user activation has been performed against a location of the touch-sensitive display screen 218 that is associated with a representation of the parameter displayed on the touch-sensitive display screen 218. In some embodiments, if the PMP device 200 determines that the user activation was detected on the touch-sensitive display screen 218 (“YES” of 502), the PMP device 200 determines whether the user activation (for example, the user's touch gesture) was performed on a parameter reporting frame 330 associated with a representation of the parameter displayed on the touch-sensitive display screen 218 (504).

If the PMP device 200 determines that the user activation has not been performed on the associated parameter reporting frame 330 of the touch-sensitive display screen 218 (“NO” of 504), the operation of the PMP device 200 returns to block 406 where the PMP device 200 continues to display the automated reading within the associated parameter reporting frame 330 (406).

Otherwise (“YES” of 504), the PMP device 200 then determines whether the user activation is held at least for a predetermined period of time (506). For example, the PMP device 200 can determine whether the touch gesture by the user against the associated parameter reporting frame 330 on the touch-sensitive display screen 218 continues for a predetermined period of time (for example, three seconds).

If the user activation (for example, the touch gesture) is held for the predetermined period of time (“YES” of 506), the PMP device 200 detects the manual override selection (408) and, thus, the operation of the PMP device 200 moves to block 410 where the PMP device 200 displays the virtual input device on the touch-sensitive display screen 218 (410). If the user activation is not held at least for the predetermined period of time (“NO” of 506), the operation of the PMP device 200 returns to block 406 where the PMP device 200 continues to display the automated reading within the associated parameter reporting frame 330 (406).

FIGS. 6A-6D are views of an example workflow screen 300, illustrating an example operation of the PMP device 200 for obtaining a manual reading for an episodic parameter with a spot profile. In this example, the PMP device 200 operates to display NIBP, pulse rate and SpO2 of a patient. These parameters are displayed on the touch-sensitive display screen 218 only when a clinician obtains measurements of these parameters from the patient at discrete instances. Under this circumstance, the NIBP is an episodic parameter with a spot profile. For clarity purposes, therefore, the operation of the PMP device 200 is hereinafter described only with reference to the NIBP parameter.

As shown in FIG. 6A, the workflow screen 300 displays an automated reading of the NIBP, which reads “110/72.” This automated reading or representation of the NIBP has been measured from a patient via the HCE module installed in the PMP device 200. In some situations, a clinician may want to replace the automated reading with a manual reading of the NIBP. For example, when the automated reading indicates a measurement of the NIBP beyond a range that is typically expected for the patient, the clinician may choose to acquire a measurement of the NIBP of the patient from another instrument that is not associated with the PMP device 200. For example, the clinician may want to use an aneroid sphygmomanometer to obtain a more accurate measurement of the patient's blood pressure.

If the clinician wants to clear the automated reading and enter a manual reading, the clinician clicks or touches on the touch-sensitive display screen 218 to activate a manual override selection. In response to the clinician's touch gesture against the touch-sensitive display screen 218, the PMP determines the touch gesture as the manual override selection. In some embodiments, the PMP device 200 requires the clinician to touches a predetermined location on the touch-sensitive display screen 218 to commence the manual override selection with respect to the NIBP reading. For example, the clinician can activate the manual override selection for the NIBP reading by touching any location within the NIBP frame 330a. In other embodiments, the touch gesture must be made within the measurements field 333a.

In some embodiments, the activation of the manual override selection requires the touch gesture to be held for a predetermined period of time against the touch-sensitive display screen 218. For example, the clinician is required to continue to click a predetermined location of the touch-sensitive display screen 218 for three seconds before the PMP device 200 detect the manual override selection from the clinician.

In some embodiments, the tough gesture can be performed with any part of the clinician's body, such as the clinician's finger 350. In other embodiments, a touch-sensitive pen or any type of touch-sensitive input devices can be used for the touch gesture against the touch-sensitive display screen 218.

FIG. 6B shows that once the manual override selection is activated, a virtual input device 352 appears on the touch-sensitive display screen 218. The virtual input device 352 is used for the clinician to enter a manual reading for the NIBP obtained from an alternative instrument unassociated with the PMP device 200. In this example, the virtual input device 352 is shown at the center of the touch-sensitive display screen 218 while blocking part of the parameter reporting frames 330. However, the virtual input device 352 can be display at any location of the touch-sensitive display screen 218.

The virtual input device 352 contains a numeral keypad 354, a systolic blood pressure input box 356, a diastolic blood pressure input box 358, a delete button 360, a “OK” button 362, and a “Cancel” button 364. The numeral keypad 354 provides ten-digit numerals for the user to enter manual readings. The systolic blood pressure input box 356 is configured to display numerals as the user enters a manual reading for a systolic blood pressure, and the diastolic blood pressure input box 358 is configured to display numerals as the user enters a manual reading for a diastolic blood pressure. The delete button 360 can be used to remove each numeral the user has just entered. In other embodiments, the entire reading for either the systolic blood pressure or the diastolic blood pressure, or both, can be deleted when the delete button 360 is clicked. The “OK” button 362 is arranged for the user to finalize the entry of the manual reading of the NIBP and save the measurement into the PMP device 200. The “Cancel” button 364 is used to cease to enter a manual reading and return the workflow screen 300 without changing the automated readings of parameters. FIG. 6C shows that the user has entered a systolic blood pressure value of “125” and a diastolic blood pressure value of “82”, using the numeral keypad 354.

Once the user clicks the “OK” button after filling out the systolic blood pressure input box 356 and the diastolic blood pressure input box 358, the workflow screen 300 displays the systolic and diastolic blood pressure values that have just entered by the user, as shown in FIG. 6D. In particular, the manual readings of the systolic and diastolic blood pressure values (“125/82” in this example) are represented within the measurements field 333a of the NIBP frame 330a.

In some embodiments, the values of a manual reading for a parameter, which are entered by the user, are validated for accuracy. For example, upper and lower thresholds for each parameter can be set. If the user selects a value outside of the upper and lower thresholds, the PMP device 200 can prevent such a selection. In addition, the PMP device 200 can alert the user. For example, if the user types in “180” for a manual reading of the systolic blood pressure value, and the upper threshold set for the systolic blood pressure is “160,” then the PMP device will not allow the user to enter “180” for the systolic blood pressure value.

In other embodiments, the PMP device 200 validates that the value entered by a user as a manual reading for a parameter is outside an alarm range for the parameter. If the value exceeds the alarm range for the parameter, the PMP device 200 activates an alarm for the parameter in various ways as explained above. For example, the PMP device 200 can display an alarm message describing that the value entered is outside the alarm threshold for the parameter. Alternatively, the PMP device 200 can emit an alarm sound to indicate that the value entered is outside the alarm threshold for the parameter.

In still other embodiments, the PMP device 200 is configured to validate that the value entered by the user as a manual reading for the parameter is outside a sensing range of the HCE module installed in the PMP device 200. A sensing unit of each HCE module that is configured to measure a physiological parameter has its own sensing range with upper and lower limits. When a measurement of a parameter is outside the sensing range of the HCE module for the parameter, the HCE module is inoperable for obtaining the measurement of the parameter. If the PMP device 200 determines that the value input by the user as a manual reading for the parameter exceeds a sensing range of the HCE module for the parameter, the PMP device 200 is configured to reject to receive the value entered by the user. In some embodiments, the “OK” button 362 remains inactive when the user has entered a value outside the sensing range, and thus the user cannot hit the “OK” button 362 to save the value.

In some embodiments, the PMP device 200 also represents a source representation in response to the entry of the manual reading of the parameter. As shown in FIG. 6D, the extended label field 336a of the NIBP frame 330a can be updated to represent the text “Manual.” The text “Manual” indicates that the current representation of the NIBP value (“125/82” in this example) is a manual reading, which has been acquired by a user from an alternative source or instrument unassociated with the PMP device 200. In the example of FIG. 6D, the source representation is located within the extended label field 336a.

In some embodiments, the manual reading of the NIBP, which currently reads “125/82”, remains on the workflow screen 300 until a next reading of the NIBP is obtained via the HCE module of the PMP device 200. In other embodiments, the manual reading of the NIBP can continue to be represented on the workflow screen 300 until a second manual reading of the NIBP is acquired in response to a second manual override selection by a user against the touch-sensitive display screen 218. In still other embodiments, the manual reading of the NIBP remains until it is stored in response to a user's selection of the save selection button 340.

FIGS. 7A-7F are views of an example workflow screen 300, illustrating an example operation of the PMP device 200 for obtaining a manual reading for an episodic parameter with an intervals profile. In this example, the PMP device 200 operates to automatically measure, and display, the blood pressure of a patient at a predetermined interval. Thus, in this example, the NIBP is an episodic parameter with an intervals profile.

The operation of the PMP device 200 illustrated in FIGS. 7A-7D are the same as the operation of the PMP device 200 as explained with reference to FIGS. 6A-6D. For brevity purposes, the explanation of FIGS. 7A-7D is omitted.

In the example of FIGS. 7A-7F, however, the workflow screen 300 can be configured to represent a type of the parameter in each parameter reporting frame 330. In the example of FIG. 7A, the NIBP frame 330a of the workflow screen 300 displays the text “INTERVALS” within the extended label field 336a, which represents that the NIBP at issue is an interval parameter. In other embodiments, the workflow screen 300 represents a source of a measurement of the parameter. For example, the source of a measurement of a parameter can represent that the measurement is either an automatic reading or a manual reading. In the example of FIG. 7A, the text “Automatic” is displayed within the extended label field 336a, which indicates that the measurement of the NIBP (“110/72”) has been obtained via the HCE module of the PMP device 200.

Furthermore, the PMP device 200 also operates to update the source representation in response to the entry of the manual reading of the parameter. For example, as shown in FIG. 7D, the extended label field 336a of the NIBP frame 330a is updated to represent the text “Manual” by replacing the text “Automatic” that has been displayed before the manual reading was entered. The text “Manual” indicates that the current representation of the NIBP value (“125/82” in this example) is a manual reading, which has been acquired by a user from an alternative source or instrument unassociated with the PMP device 200.

As in the example of FIGS. 6A-6D, the manual reading of the NIBP, which currently reads “125/82”, can remain on the workflow screen 300 until a next reading of the NIBP is obtained via the HCE module of the PMP device 200, until a second manual reading of the NIBP is acquired in response to a second manual override selection by a user against the touch-sensitive display screen 218, and/or until the manual reading is stored in response to a user's selection of the save selection button 340.

FIGS. 7E-7F illustrate that the PMP device 200 is in process of acquiring a new automated reading of the NIBP from the patient after a predetermined period of time. Because the NIBP in this example is measured at a predetermined interval, the PMP device 200 operates to automatically obtain the blood pressure from the patient at the interval. Once the PMP device 200 obtains the new automated reading of the NIBP, it displays the reading on the touch-sensitive display screen 218 by replacing the previous manual reading with the new reading of the NIBP. The PMP device 200 is also configured to update the source indication within the extended label field 336a from the text “Manual” to “Automatic.”

FIG. 7E shows an example workflow screen 300 when the PMP device 200 is in process of taking a new measurement of the blood pressure from the patent via the HCE module. For example, a cuff of the HCE module is inflating around the arm of the patient during this period of time. In this example, the NIBP frame 330a represents the text “0” within the measurements field 334a. The source indication within the extended label field 336a is updated to represent the text “Automatic” instead of “Manual.” In other embodiments, the NIBP frame 330a is configured to continue to represent the manual reading of the blood pressure (“125/82” in this example) that has been displayed, until a new measurement of the blood pressure is finally obtained by the PMP device 200.

FIG. 7F illustrates that an automated reading of the NIBP is represented within the NIBP frame 330a once the measurement of the NIBP is complete. The measurements field 334a of the NIBP frame 330a represents a new reading labeled as the text “107/68.” The extended label field 336a represents the source of the new reading as the text “Automatic,” which indicates that the reading has been automatically obtained via the HCE module of the PMP device 200.

FIG. 8 is a flowchart illustrating an example operation 800 performed by the PMP device 200 for obtaining and overriding measurements of a continuous parameter, such as SpO2, EtCO2, respiratory rate, and pulse rate. In this example, the operations 802-818 are the same as the operations 402-418 as illustrated with reference to FIG. 4. Thus, for brevity purposes, the explanation of the operations 802-818 is omitted.

The PMP device 200 continues to represent the manual reading of the parameter on the touch-sensitive display screen 218 for a predetermined period of time. In the meantime, the PMP device 200 continues to measure the parameter from the patient. Although the measurement of the parameter is continuously acquired by the PMP device 200, it was not represented on the workflow screen 300 for the predetermined period of time, during which the manual reading of the parameter is displayed on the workflow screen 300.

Once the PMP device 200 display the manual reading of the parameter within the parameter reporting frame 330 (818), the PMP device 200 determines whether a predetermined period of time lapsed (820). In some embodiments, such a predetermined period of time is configurable by a user. In other embodiments, the predetermined period of time is set as a fixed value, such as one minute.

If the PMP device 200 determines that the predetermined period of time has not passed since it displays the manual reading of the parameter within the associated parameter reporting frame (“NO” of 820), the PMP device 200 continues to display the manual reading of the parameter previously obtained from the manual override selection by the user against the touch-sensitive display screen 218.

If the PMP device 200 determines that the predetermined period of time has passed (“YES” of 820), the PMP device 200 operates to display a representation of the continuous measurement of the parameter automatically obtained by the PMP device 200 by replacing the representation of the manual reading of the parameter with the representation of the parameter that is continuously obtained by the PMP device 200. In some embodiments, if the PMP device 200 determines that the predetermined period of time has passed (“YES” of 820), the PMP device 200 operates to remove the representation of the manual reading of the parameter (828) from the associated parameter reporting frame 330 and, subsequently, display the new automated readings that are continuously acquired by the PMP device 200 within the parameter reporting frame 330 (for example, within the associated measurements field 334) on the touch-sensitive display screen 218 (806).

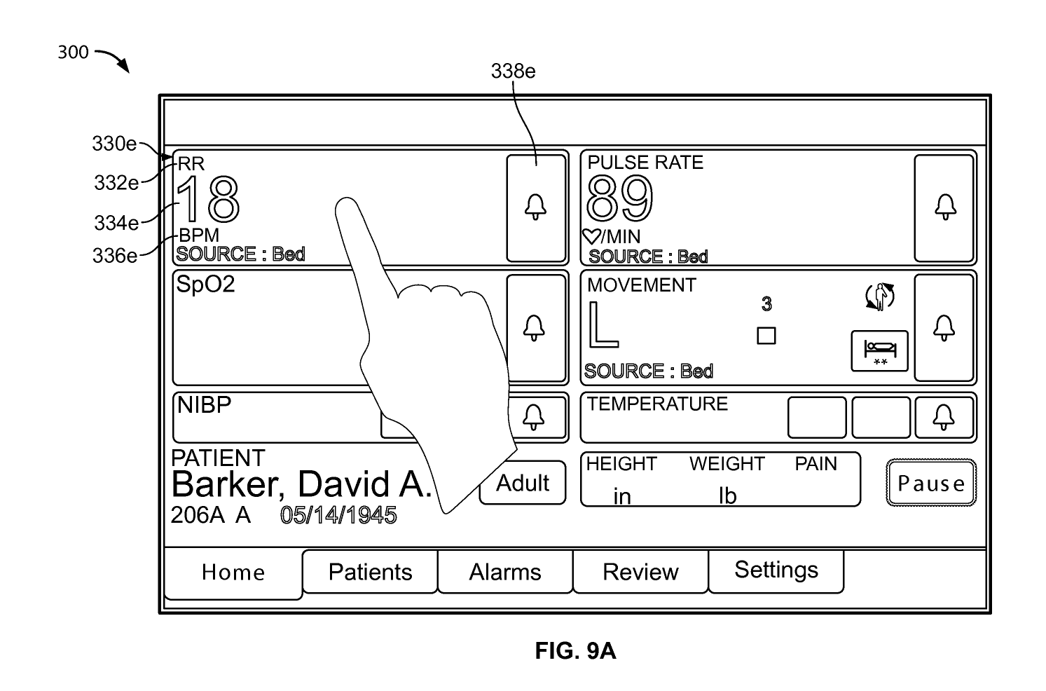

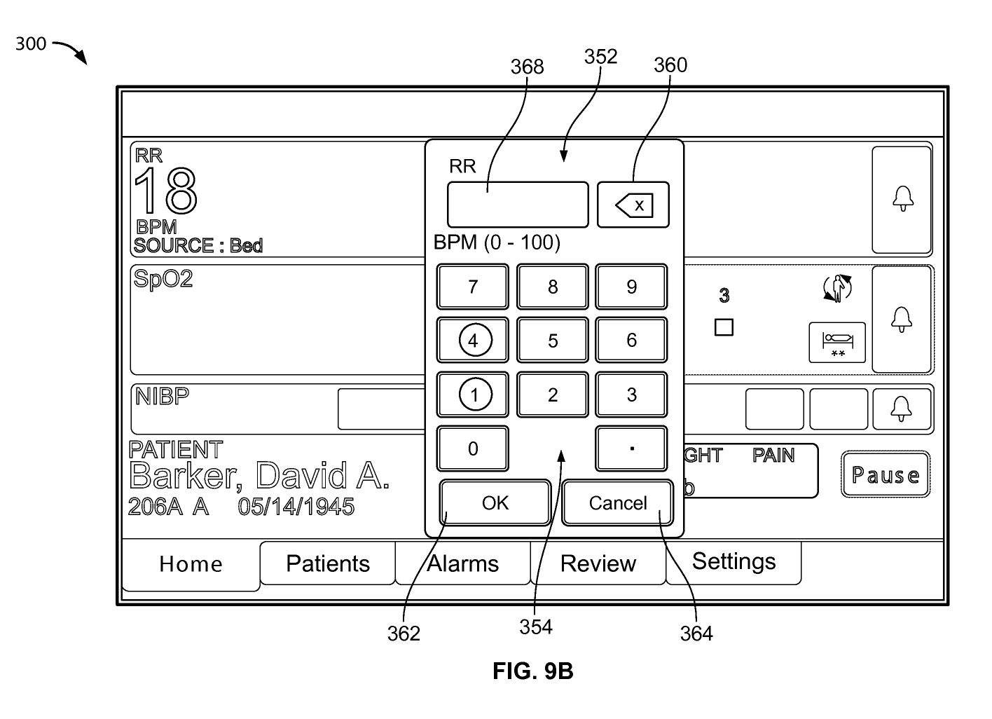

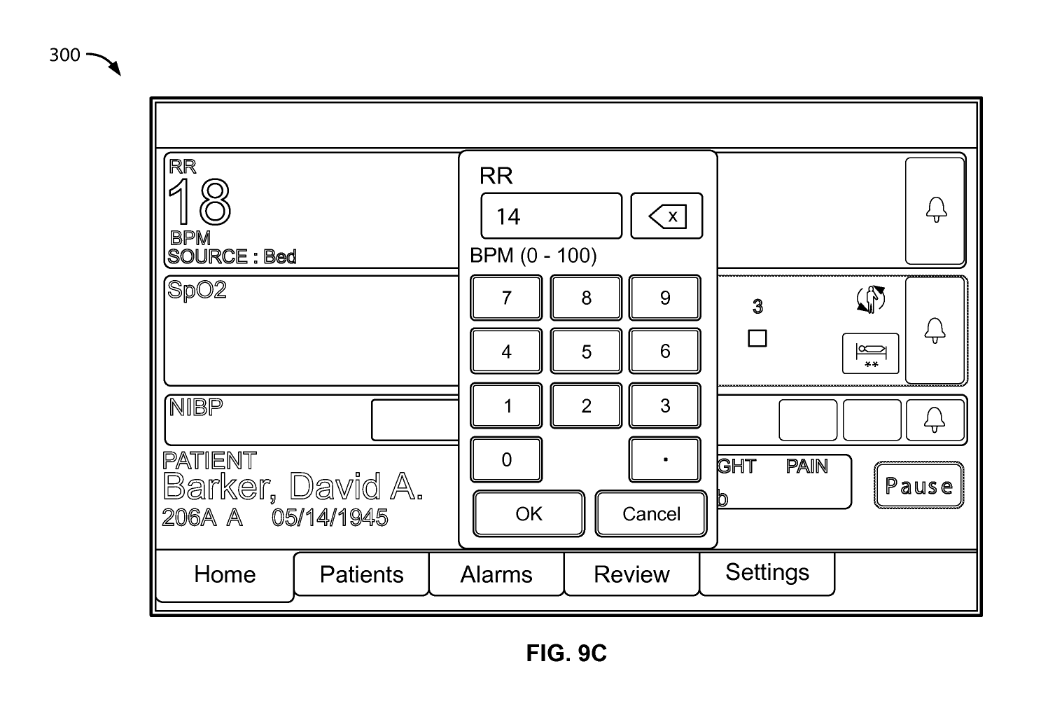

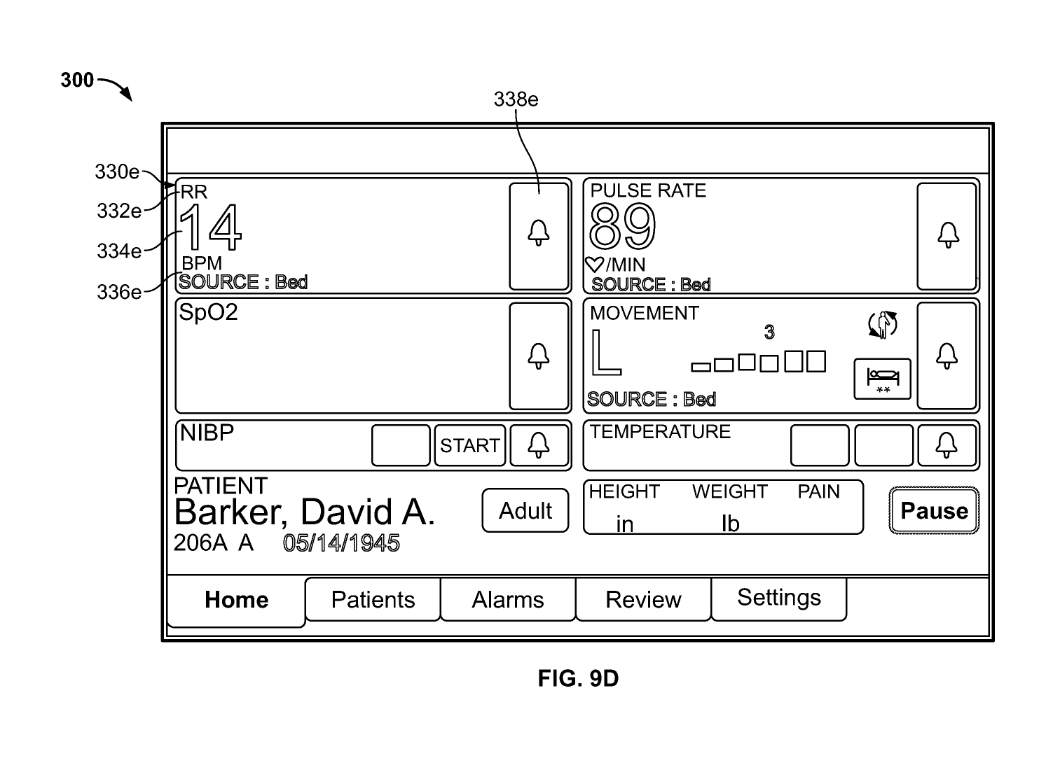

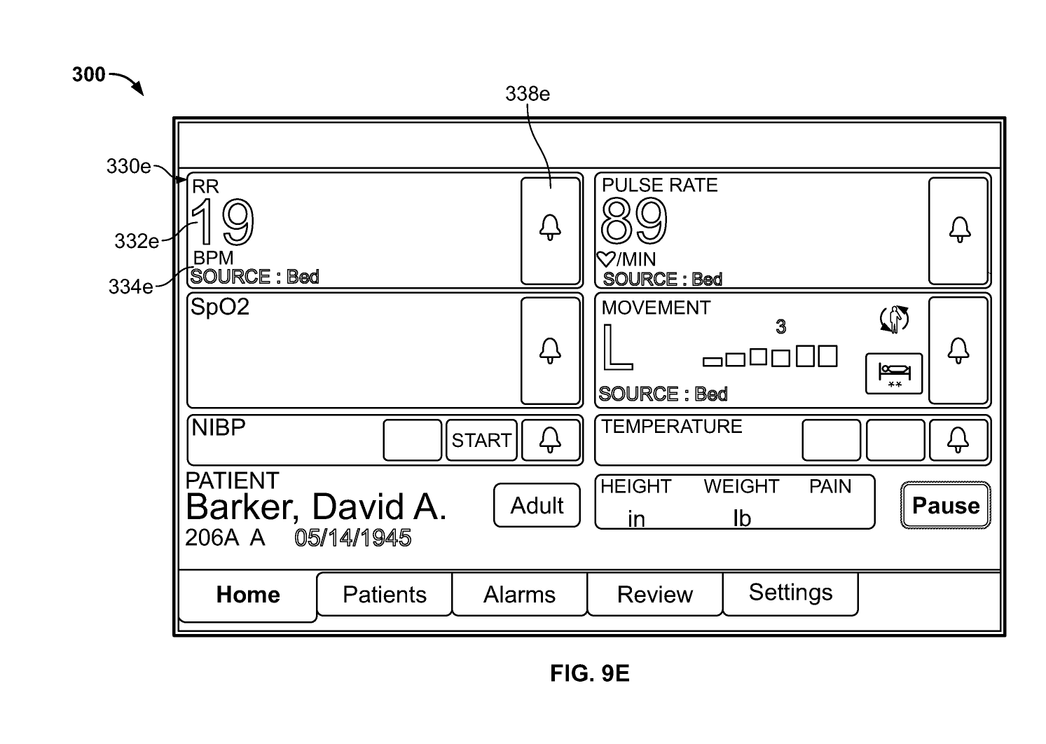

FIGS. 9A-9E are views of an example workflow screen 300, illustrating an example operation of the PMP device 200 for obtaining a manual reading for a continuous parameter. In this example, the PMP device 200 operates to display, among other things, respiratory rate, which is referred to as the text “RR,” pulse rate, and SpO2. These parameters are continuous parameters. For clarity purposes, the operation of the PMP device 200 is hereinafter described only with reference to the respiratory rate parameter.

As shown in FIG. 9A, the workflow screen 300 displays an automated reading of the respiratory rate, which reads “18.” This automated reading of the respiratory rate is continuously measured from a patient via the HCE module installed in the PMP device 200. Thus, the representation of the automated reading of the respiratory rate changes as the measurement of the respiratory rate from the patient varies. In the meantime, as in the previous example for an episodic parameter, a clinician can override the automated reading with a manual reading of the respiratory rate.

The operation of the PMP device 200 that obtains such a manual readings of the respiratory rate, as illustrated in FIGS. 9A-9D, are substantially the same as the operation of the PMP device 200 as explained with reference to FIGS. 6A-6D, except that the parameters displayed on the workflow screen 300 in FIGS. 9A-9D are different from the parameters illustrated in FIGS. 6A-6D. As shown in FIG. 9D, the workflow screen 300 (in particular, a RR frame 330e) displays a manual reading for the respiratory rate, which reads “14,” obtained in response to the user's manual override selection as described with respect to FIGS. 9A-9C. For brevity purposes, the remaining explanation of the operation of the PMP device 200 as illustrated in FIGS. 9A-9D is omitted.

In the example of FIGS. 9A-9E, the workflow screen 300 can be configured to represent the source of a measurement of the parameter. For example, the source of a measurement of a parameter can represent that the measurement is either an automatic reading or a manual reading. In the example of FIG. 9A, the text “Source: Bed” is displayed within an extended label field 336e, which indicates that the measurement of the respirator rate (“18”) has been obtained via the HCE module of the PMP device 200 from a patient at the bedside.

Furthermore, the PMP device 200 also operates to update the source representation in response to the entry of the manual reading of the parameter. For example, as shown in FIG. 9D, the extended label field 336e of the RR frame 330e is updated to represent the text “Manual” by replacing the text “Bed” that has been displayed before the manual reading was entered. The text “Manual” indicates that the current representation of the respiratory rate value (“18” in this example) is a manual reading, which has been acquired by a user from an alternative source or instrument unassociated with the PMP device 200.

In this example for a continuous parameter, the manual reading for the respiratory rate, which currently reads “18”, can remain on the workflow screen 300 for a predetermined period of time. In some embodiments, such a predetermined period of time is configurable by a user. In other embodiments, the predetermined period of time is set as a fixed value, such as one minute.

FIG. 9E shows that once the predetermined period of time lapsed, the PMP has updated the representation of the respirator rate with a new automated reading from the PMP device 200. In this example, at the moment when the predetermined period of time has passed since the PMP device 200 displayed the manual reading for the respirator rate, the measurement of the respiratory rate continuously obtained by the PMP device 200 reads the text “19” and the PMP device 200 display this measurement on the RR frame 330e of the workflow screen 300 by replacing the manual reading (“14”) with the new automated reading (“19”). Furthermore, the extended label filed 336e is updated to represent the source of the new readings as the text “Bed,” which again indicates that the reading has been automatically obtained by the PMP device 200 at the bedside.

FIG. 10 is a schematic view of an example review screen 500. The review screen 500 is designed for a user to review a patient record that includes saved measurements of physiological parameters and attributes of the patients. The PMP device 200 displays the review screen 500 when a user selects the review tab 319d (FIG. 3). In some embodiments, the review screen 500 contains a review table 542. The review table 542 includes a different set of measurements of physiological parameters of a patient. The measurements of physiological parameters can include both automated readings and manual readings for the parameters.

In some embodiments, the manual readings for a parameter stored in the patient record on the PMP device 200 are represented with a manual source indicator 550. The manual source indicator 550 is designed to visually indicate that the associated reading has been obtained from an instrument or source different from the HCE modules of the PMP device 200, and to differentiate the manual readings from automated readings. In some embodiments, the manual source indicator 550 is a symbol, such as (*), and is located adjacent to the associated manual reading for the parameter, such as at the upper right side of the text for the manual reading.

In some embodiments, when the patient record containing the manual readings with the manual source indicators are sent electronically to a host system or EMR system, the host system or EMR system can also display the manual source indicators with the associated manual readings to visually represent that the readings accompanying the manual source indicators are manual readings for the parameters and to differentiate the manual readings from automated readings. Accordingly, automated readings and manual readings for physiological parameters can be documented in a single patient record and managed at a single device.

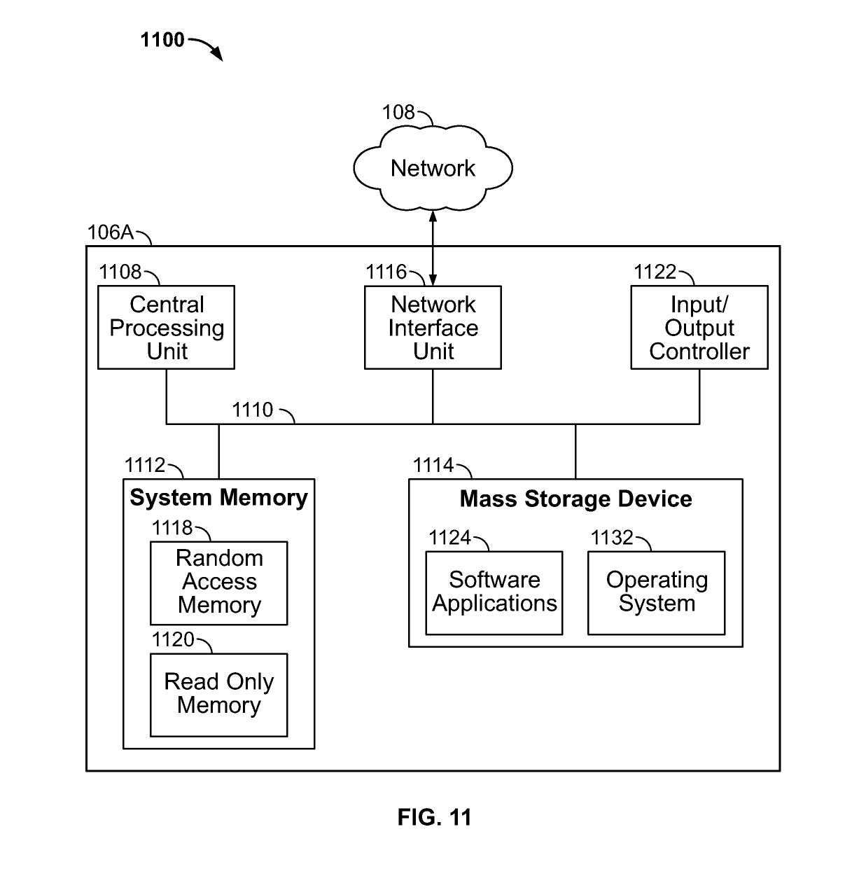

FIG. 11 illustrates example physical components of the PMP device 200. As illustrated in the example of FIG. 11, the PMP device 200 include at least one central processing unit (“CPU”) 1108, a system memory 1112, and a system bus 1110 that couples the system memory 1112 to the CPU 1108. The system memory 1112 includes a random access memory (“RAM”) 1118 and a read-only memory (“ROM”) 1120. A basic input/output system containing the basic routines that help to transfer information between elements within the PMP device 200, such as during startup, is stored in the ROM 1120. The PMP device 200 further includes a mass storage device 1114. The mass storage device 1114 is able to store software instructions and data.

The mass storage device 1114 is connected to the CPU 1108 through a mass storage controller (not shown) connected to the bus 1110. The mass storage device 1114 and its associated computer-readable data storage media provide non-volatile, non-transitory storage for the PMP device 200. Although the description of computer-readable data storage media contained herein refers to a mass storage device, such as a hard disk or CD-ROM drive, it should be appreciated by those skilled in the art that computer-readable data storage media can be any available non-transitory, physical device or article of manufacture from which the PMP device 200 can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the PMP device 200.

According to various embodiments of the invention, the PMP device 200 may operate in a networked environment using logical connections to remote network devices through the network 108, such as a local network, the Internet, or another type of network. The PMP device 200 connects to the network 108 through a network interface unit 1116 connected to the bus 1110. It should be appreciated that the network interface unit 1116 may also be utilized to connect to other types of networks and remote computing systems. The PMP device 200 also includes an input/output controller 1122 for receiving and processing input from a number of other devices, including a keyboard, a mouse, a touch user interface display screen, or another type of input device. Similarly, the input/output controller 1122 may provide output to a touch user interface display screen, a printer, or other type of output device.

As mentioned briefly above, the mass storage device 1114 and the RAM 1118 of the PMP device 200 can store software instructions and data. The software instructions include an operating system 1132 suitable for controlling the operation of the PMP device 200. The mass storage device 1114 and/or the RAM 1118 also store software instructions, that when executed by the CPU 1108, cause the PMP device 200 to provide the functionality of the PMP device 200 discussed in this document. For example, the mass storage device 1114 and/or the RAM 1118 can store software instructions that, when executed by the CPU 1108, cause the PMP device to display the workflow screen 300 and other screens.

It should be appreciated that various embodiments can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various embodiments, those of ordinary skill in the art will understand that many modifications may be made thereto within the scope of the claims that follow. For example, it should be appreciated that the screens illustrated in this document are merely examples and that in other embodiments equivalent screens can have different contents and appearances. Accordingly, it is not intended that the scope of the invention in any way be limited by the above description, but instead be determined entirely by reference to the claims that follow.

What is claimed is:

1. A parameter measuring device comprising:
a central processing unit configured to control operation of the parameter measuring device;
an input device configured to allow a user to input a measurement of the parameter; and
a set of one or more computer readable data storage media storing software instructions that, when executed by the central processing unit, cause the parameter measuring device to:
obtain a first measurement of a parameter;
display a workflow screen containing a first representation of the parameter based on the first measurement of the parameter;
detect a first manual override selection corresponding to interaction of the user in relation to the input device;
receive a second measurement of the parameter via the input device; and
display a second representation of the parameter based on the second measurement of the parameter by replacing the first representation of the parameter with the second representation of the parameter.

2. The device of claim 1, wherein the input device is a touch-sensitive display screen, and wherein the software instructions, when executed by the central processing unit, further cause the parameter measuring device to display a virtual input device on the touch-sensitive display screen, the virtual input device configured to allow the user to input the second measurement of the parameter.

3. The device of claim 2, wherein the software instructions, when executed by the central processing unit, further cause the parameter measuring device to:
obtain a third measurement of the parameter; and
display, on the touch-sensitive display screen, a third representation of the parameter based on the third measurement of the parameter by replacing the second representation of the parameter with the third representation of the parameter.

4. The device of claim 2, wherein the software instructions, when executed by the central processing unit, further cause the parameter measuring device to:
detect a second manual override selection corresponding to interaction of the user in relation to the touch-sensitive display screen;
display the virtual input device on the touch-sensitive display screen;
receive a third measurement of the parameter input through the virtual input device; and
display, on the touch-sensitive display screen, a third representation of the parameter based on the third measurement of the parameter by replacing the second representation of the parameter with the third representation of the parameter.

5. The device of claim 2, wherein the workflow screen contains a save button, the save button configured for the software instructions, when executed by the central processing unit, to cause the parameter measuring device to save measurements of parameters displayed on the touch-sensitive display screen in response to selection of the save button; and
wherein the software instructions, when executed by the central processing unit, cause the parameter measuring device to:
save the second measurement of the parameter in response to selection of the save button after displaying, on the touch-sensitive display screen, the second representation of the parameter; and
clear the second representation of the parameter on the touch-sensitive display screen.

6. The device of claim 2, wherein the first measurement of the parameter is a continuous parameter, and
wherein the software instructions, when executed by the central processing unit, cause the parameter measuring device to:
display, on the touch-sensitive display screen, the second representation of the parameter based on the second measurement of the parameter, for a predetermined period of time, by replacing the first representation of the parameter with the second representation of the parameter;
clear the second representation of the parameter after the predetermined period of time; and
display, on the touch-sensitive display screen, a third representation of the parameter based on the first measurement of the parameter.

7. The device of claim 2, wherein the software instructions, when executed by the central processing unit, cause the parameter measuring device to:
detect a touch gesture on the touch-sensitive display screen;
determine whether the touch gesture is made over the first representation of the parameter; and
determine whether the touch gesture is held for a predetermined period of time, wherein the first manual override selection is detected when the touch gesture is made over the first representation of the parameter for the predetermined period of time.

8. The device of claim 2, wherein the software instructions, when executed by the central processing unit, cause the parameter measuring device to:
obtain a source of the measurement of a parameter; and
display, on the touch-sensitive display screen, a source representation of the parameter based on the source of the measurement of the parameter.

9. The device of claim 2, wherein the software instructions, when executed by the central processing unit, cause the parameter measuring device to:
display, on the touch-sensitive display screen, the first source representation of the parameter with respect to the first representation of the parameter, the first source representation of the parameter indicating the first representation of the parameter is obtained from the parameter measuring device; and
display, on the touch-sensitive display screen, the second source representation of the parameter with respect to the second representation of the parameter, the second source representation of the parameter indicating the second representation of the parameter is obtained from a different source from the parameter measuring device.

10. The device of claim 2, wherein the parameter measuring device comprises a sensing module for obtaining measurements of a given parameter, the sensing module having a sensing range with an upper limit and a lower limit for the given parameter and being inoperable when the measurement of the given parameter is outside the sensing range for the given parameter, and
wherein the software instructions, when executed by the central processing unit, cause the parameter measuring device to:
validate that the measurement of the parameter input by the user falls outside the sensing range; and
reject to receive the measurement of the parameter input by the user when the measurement of the parameter input by the user falls outside the sensing range.

11. The device of claim 2, wherein the software instructions, when executed by the central processing unit, cause the parameter measuring device to:
validate that the second measurement of the parameter is outside an alarm range for the parameter, and
display, on the touch-sensitive display screen, an alarm message describing an alarm when the alarm is active, the alarm being active when the second measurement of the parameter is outside the alarm range for the parameter.

12. The device of claim 2, wherein the software instructions, when executed by the central processing unit, cause the parameter measuring device to:
validate that the second measurement of the parameter is outside an alarm range for the parameter, and
emit an alarm sound when an alarm is active, the alarm being active when the second measurement of the parameter is outside the alarm range for the parameter.

13. The device of claim 12, wherein the alarm range is configurable by the user.

14. The device of claim 2, wherein the workflow screen contains at least one parameter reporting frame, the at least one parameter reporting frame configured to display representations of parameters.

15. The device of claim 2, wherein the software instructions, when executed by the central processing unit, cause the parameter measuring device to:
detect a touch gesture on the touch-sensitive display screen;
determine whether the touch gesture is made over a parameter reporting frame associated with the first representation of the parameter; and
determine whether the touch gesture is held for a predetermined period of time, wherein the first manual override selection is detected when the touch gesture is made over the parameter reporting frame associated with the first representation of the parameter for the predetermined period of time.

16. The device of claim 2, wherein the device is a physiological parameter measuring platform device.

17. A method for measuring parameters, the method comprising:
displaying, by a parameter measuring device, a workflow screen on a touch-sensitive display screen;
obtaining a first measurement of a parameter;
displaying, within the workflow screen on the touch-sensitive display screen, a first representation of the parameter based on the first measurement of the parameter;
detecting a first manual override selection corresponding to interaction of a user in relation to the touch-sensitive display screen;
displaying a virtual input device on the touch-sensitive display screen, the virtual input device configured to allow the user to input a measurement of the parameter;
receiving a second measurement of the parameter; and
displaying, on the touch-sensitive display screen, a second representation of the parameter based on the second measurement of the parameter by replacing the first representation of the parameter with the second representation of the parameter.

18. The method of claim 17, further comprising:
obtaining a third measurement of the parameter; and
displaying, on the touch-sensitive display screen, a third representation of the parameter based on the third measurement of the parameter by replacing the second representation of the parameter with the third representation of the parameter.

19. The method of claim 17, further comprising:
detecting a second manual override selection corresponding to interaction of the user in relation to the touch-sensitive display screen;
displaying the virtual input device on the touch-sensitive display screen;
receiving a third measurement of the parameter input through the virtual input device; and
displaying, on the touch-sensitive display screen, a third representation of the parameter based on the third measurement of the parameter by replacing the second representation of the parameter with the third representation of the parameter.

20. A computer-readable storage medium comprising software instructions that, when executed, cause a parameter measuring device to:
obtain a first measurement of a parameter;
display, on a touch-sensitive display screen, a workflow screen containing a first representation of the parameter based on the first measurement of the parameter;
detect a first manual override selection corresponding to interaction of a user in relation to the touch-sensitive display screen;
display a virtual input device on the touch-sensitive display screen, the virtual input device configured to allow the user to input a measurement of the parameter;
receive a second measurement of the parameter;
display, on the touch-sensitive display screen, a second representation of the parameter based on the second measurement of the parameter by replacing the first representation of the parameter with the second representation of the parameter;
when the parameter is an episodic parameter:
determine whether a third measurement of the parameter is obtained; a second manual override selection corresponding to interaction of the user in relation to the touch-sensitive display screen is detected; or
a save button within the workflow screen is selected;
when the third measurement of the parameter is obtained, display, on the touch-sensitive display screen, a third representation of the parameter based on the third measurement of the parameter by replacing the second representation of the parameter with the third representation of the parameter;
when the second manual override selection is detected:
display the virtual input device on the touch-sensitive display screen;
receive a fourth measurement of the parameter input through the virtual input device; and
display, on the touch-sensitive display screen, a fourth representation of the parameter based on the fourth measurement of the parameter by replacing the second representation of the parameter with the fourth representation of the parameter,
if the save button is selected:
save the second measurement of the parameter in response to selection of the save button after displaying, on the touch-sensitive display screen, the second representation of the parameter; and
clear the second representation of the parameter on the touch-sensitive display screen,
when the parameter is a continuous parameter:
display, on the touch-sensitive display screen, the second representation of the parameter based on the second measurement of the parameter, for a predetermined period of time, by replacing the first representation of the parameter with the second representation of the parameter;
clear the second representation of the parameter after the predetermined period of time; and
display, on the touch-sensitive display screen, a fifth representation of the parameter based on the first measurement of the parameter,
obtain sources of measurements of the parameter; and
display, on the touch-sensitive display screen, source representations of the parameter based on the sources of the measurements of the parameter.
